(19) United States
(12) Patent Application Publication
(10) Pub. No.: US 2026/0045977 A1
(43) Pub. Date: Feb. 12, 2026

(54) ANALOG BEAM NULLING FOR MU-MIMO

(71) Applicant: Samsung Electronics Co., Ltd., Suwon-si (KR)

(72) Inventors: Mustafa Furkan Ozkoc, The Colony, TX (US); Jianhua Mo, Allen, TX (US); Jeehwan Noh, Suwon-si (KR); Young Han Nam, Plano, TX (US)

(21) Appl. No.: 19/079,101

(22) Filed: Mar. 13, 2025

Related U.S. Application Data
(60) Provisional application No. 63/679,690, filed on Aug. 6, 2024.

(51) Int. Cl. H04B 7/0452

(52) U.S. Cl. CPC H04B 7/0452

(57) ABSTRACT

An embodiment provides for a base station (BS) in a wireless network, the BS including memory and a processor coupled to the memory. The processor can cause the BS to determine a first gain region of a first beam index associated with serving a first user equipment (UE) and determine a first interference region of the first beam index associated with serving a second user equipment (UE). The processor can further calculate a beamforming weight of the first beam index using an analog null algorithm wherein the first gain region and the first interference region are inputs to the analog null algorithm to optimize for a threshold criterion. The processor can also transmit a first beam having the beamforming weight of the first beam index as part of a multi-user multiple-input multiple-output (MU-MIMO) operation.

### CROSS-REFERENCE TO RELATED APPLICATION(S)

This application claims the benefit of priority from U.S. Provisional Application No. 63/679,690, entitled “BEAM NULLING FOR INTERFERENCE REDUCTION AND MU-MIMO PAIRING OPPORTUNITY INCREASE” filed Aug. 6, 2024, which is incorporated herein by reference in its entirety.

### TECHNICAL FIELD

This disclosure relates generally to a wireless communication system, and more particularly to, for example, but not limited to, beam management and beam nulling in wireless networks.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

The description set forth in the background section should not be assumed to be prior art merely because it is set forth in the background section. The background section may describe aspects or embodiments of the present disclosure.

### SUMMARY

An aspect of the present disclosure provides a base station (BS) in a wireless network. The BS comprises a memory and a processor coupled to the memory. The processor is configured to determine a first gain region of a first beam index associated with serving a first user equipment (UE); determine a first interference region of the first beam index associated with serving a second UE; calculate a beamforming weight of the first beam index using an analog null algorithm wherein the first gain region and the first interference region are inputs to the analog null algorithm to optimize for a threshold criterion; and transmit a first beam having the beamforming weight of the first beam index as part of a multi-user multiple-input multiple-output (MU-MIMO) operation.

In some embodiments, to determine the first interference region of the first beam, the processor is further configured to determine a second gain region of a second beam index associated with serving the second UE; determine a second interference region of the second beam index associated with serving the first UE, wherein the second interference region is equivalent to the first gain region; and calculate a second beamforming weight of the second beam index using the analog null algorithm wherein the second gain region and the second interference region are inputs to the analog null algorithm to optimize for a signal-to-leakage ratio (SLR).

In some embodiments, the processor is further configured to determine a second gain region from a plurality of gain regions corresponding to a second beam index of a plurality of beam indices associated with serving a respective plurality of UE; determine a plurality of interference regions corresponding to the plurality of beam indices based at least in part on determining the second gain region; and calculate a second beamforming weight of a plurality of beamforming weights for the plurality of beam indices using the analog null algorithm, wherein the second beamforming weight has a maximum gain at the second gain region and a minimum gain at the plurality of interference regions corresponding to the plurality of beam indices.

In some embodiments, the BS further comprises an antenna array configured to transmit one or more beams, and wherein to transmit the first beam having the first beamforming weight, the processor is further configured to adjust a phase shifter value to achieve the first beamforming weight.

In some embodiments, the first UE and the second UE are located in a first cell.

In some embodiments, the first UE is located in a first cell and the second UE is located in a second cell, wherein the first cell is co-located to the second cell.

In some embodiments, the first UE is located in a first cell and the second UE is locate in a second cell, wherein the first cell is non-co-located to the second cell.

In some embodiments, the processor is further configured to determine an initial beamforming weight using a beam tracking algorithm or a beam management module, wherein determining the gain region of the first beam index is based at least in part on determining the initial beamforming weight.

In some embodiments, the processor is further configured to compare the initial beamforming weight to a second threshold criterion and determine the initial beamforming weight fails to satisfy the second threshold criterion, wherein calculating the beamforming weight of the first beam index is based at least in part on determining the initial beamforming weight fails to satisfy the second threshold criterion.

In some embodiments, the processor is further configured to store the beamforming weight of the first beam index.

An aspect of the present disclosure provides for a method performed by a base station (BS) in a wireless network. The method comprises determining a first gain region of a first beam index associated with serving a first user equipment (UE); determining a first interference region of the first beam index associated with serving a second UE; calculating a beamforming weight of the first beam index using an analog null algorithm wherein the first gain region and the first interference region are inputs to the analog null algorithm to optimize for a threshold criterion; and transmitting a first beam having the beamforming weight of the first beam index as part of a multi-user multiple-input multiple-output (MU-MIMO) operation.

In some embodiments, to determine the first interference region of the first beam, the method includes determining a second gain region of a second beam index associated with serving the second UE; determining a second interference region of the second beam index associated with serving the first UE, wherein the second interference region is equivalent to the first gain region; and calculating a second beamforming weight of the second beam index using the analog null algorithm wherein the second gain region and the second interference region are inputs to the analog null algorithm to optimize for a signal-to-leakage ratio (SLR).

In some embodiments, the method further comprises determining a second gain region from a plurality of gain regions corresponding to a second beam index of a plurality of beam indices associated with serving a respective plurality of UE; determining a plurality of interference regions corresponding to the plurality of beam indices based at least in part on determining the second gain region; and calculating a second beamforming weight of a plurality of beamforming weights for the plurality of beam indices using the analog null algorithm, wherein the second beamforming weight has a maximum gain at the second gain region and a minimum gain at the plurality of interference regions corresponding to the plurality of beam indices.

In some embodiments, the method further comprises adjusting a phase shifter value at an antenna array configured to transmit one or more beams, wherein transmitting the first beam having the first beamforming weight, wherein transmitting the first beam is based at least in part on adjusting the phase shifter value.

In some embodiments, the first UE and the second UE are located in a first cell.

In some embodiments, the first UE is located in a first cell and the second UE is located in a second cell, wherein the first cell is co-located to the second cell.

In some embodiments, the first UE is located in a first cell and the second UE is locate in a second cell, wherein the first cell is non-co-located to the second cell.

In some embodiments, the method further comprises determining an initial beamforming weight using a beam tracking algorithm or a beam management module, wherein determining the gain region of the first beam index is based at least in part on determining the initial beamforming weight.

In some embodiments, the method further comprises comparing the initial beamforming weight to a second threshold criterion and determining the initial beamforming weight fails to satisfy the second threshold criterion, wherein calculating the beamforming weight of the first beam index is based at least in part on determining the initial beamforming weight fails to satisfy the second threshold criterion.

In some embodiments, the method further comprises storing the beamforming weight of the first beam index.

### BRIEF DESCRIPTION OF THE DRAWINGS

FIG. 1 illustrates an example of a wireless network in accordance with an embodiment.

FIGS. 2A and 2B illustrate example wireless transmit and receive paths in accordance with an embodiment.

FIG. 3A illustrates an example user equipment (UE) in accordance with an embodiment.

FIG. 3B illustrates an example gNodeB (gNB) in accordance with an embodiment.

FIG. 4 illustrates a beamforming architecture in accordance with an embodiment.

FIG. 5A illustrates a wireless system including a cell applying analog beam nulling for multi-user multiple-output (MU-MIMO) mode in accordance with an embodiment.

FIG. 5B illustrates an analog nulling algorithm for applying analog beam nulling in MU-MIMO mode in accordance with an embodiment

FIG. 6A illustrates an example block diagram for a wireless system utilizing analog beam nulling in MU-MIMO mode in accordance with an embodiment.

FIG. 6B illustrates an example analog nulling algorithm for applying analog beam nulling in MU-MIMO mode in accordance with an embodiment.

FIG. 7 illustrates an example wireless system utilizing analog beam nulling in MU-MIMO mode in accordance with an embodiment.

FIG. 8 illustrates an example wireless system utilizing analog beam nulling in MU-MIMO mode in accordance with an embodiment.

FIG. 9 illustrates a flow chart of an example process of analog beam nulling in MU-MIMO mode in accordance with an embodiment.

FIG. 10 illustrates a flow chart of an example process of analog beam nulling in MU-MIMO mode in accordance with an embodiment.

FIG. 11 illustrates an example block diagram for a wireless system utilizing analog beam nulling in MU-MIMO mode in accordance with an embodiment.

FIG. 12 illustrates a flow chart of an example process of analog beam nulling in MU-MIMO mode in accordance with an embodiment.

FIG. 13 illustrates a flow chart of an example process of analog beam nulling in MU-MIMO mode in accordance with an embodiment.

FIG. 14A illustrates an example block diagram for a wireless system utilizing analog beam nulling in MU-MIMO mode in accordance with an embodiment.

FIG. 14B illustrates a flow chart of an example process of analog beam nulling in MU-MIMO mode in accordance with an embodiment.

FIG. 15 illustrates a flow chart of an example process of analog beam nulling in MU-MIMO mode in accordance with an embodiment.

FIGS. 16A and 16B illustrate example block diagrams for a wireless system utilizing analog beam nulling in MU-MIMO mode in accordance with an embodiment.

FIG. 17 illustrates a flow chart of an example process of analog beam nulling in MU-MIMO mode in accordance with an embodiment.

FIG. 18 illustrates a flow chart of an example process of analog beam nulling in MU-MIMO mode in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed.

The 5G communication system is considered to be implemented to include higher frequency (mmWave) bands, such as 28 GHz or 60 GHz bands or, in general, above 6 GHz bands, so as to accomplish higher data rates, or in lower frequency bands, such as below 6 GHz, to enable robust coverage and mobility support. Aspects of the present disclosure may be applied to deployment of 5G communication systems, 6G or even later releases which may use THz bands. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like.

In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

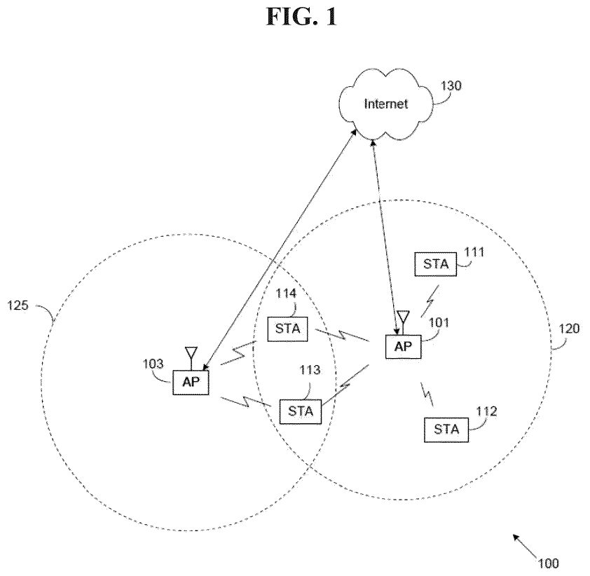

FIG. 1 illustrates an example wireless network 100 according to this disclosure. The embodiment of the wireless network 100 shown in FIG. 1 is for illustration only. Other embodiments of the wireless network 100 can be used without departing from the scope of this disclosure.

The wireless network 100 includes an gNodeB (gNB) 101, an gNB 102, and an gNB 103. The gNB 101 communicates with the gNB 102 and the gNB 103. The gNB 101 also communicates with at least one Internet Protocol (IP) network 130, such as the Internet, a proprietary IP network, or other data network.

Depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, a base station (BS), a mobile base station, a macrocell, a femtocell, a WiFi access point (AP) and the like. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to remote wireless equipment that wirelessly accesses an gNB, whether the UE is a mobile device (such as a mobile telephone or smartphone) or is normally considered a stationary device (such as a desktop computer or vending machine).

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, long-term evolution (LTE), LTE-A, WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of BS 101, BS 102 and BS 103 include 2D antenna arrays as described in embodiments of the present disclosure. In some embodiments, one or more of BS 101, BS 102 and BS 103 support the codebook design and structure for systems having 2D antenna arrays.

Although FIG. 1 illustrates one example of a wireless network 100, various changes may be made to FIG. 1. For example, the wireless network 100 can include any number of gNBs and any number of UEs in any suitable arrangement. Also, the gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

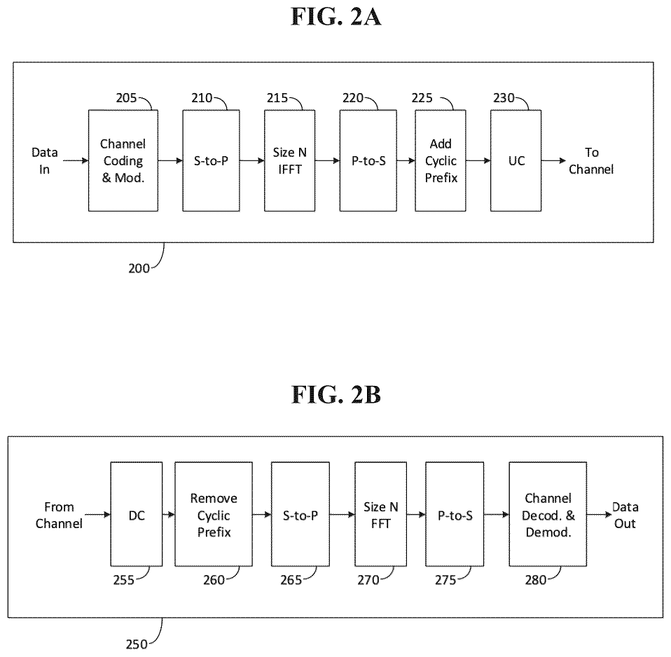

FIGS. 2A and 2B illustrate example wireless transmit and receive paths according to this disclosure. In the following description, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments, the receive path 250 is configured to support the codebook design and structure for systems having 2D antenna arrays as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

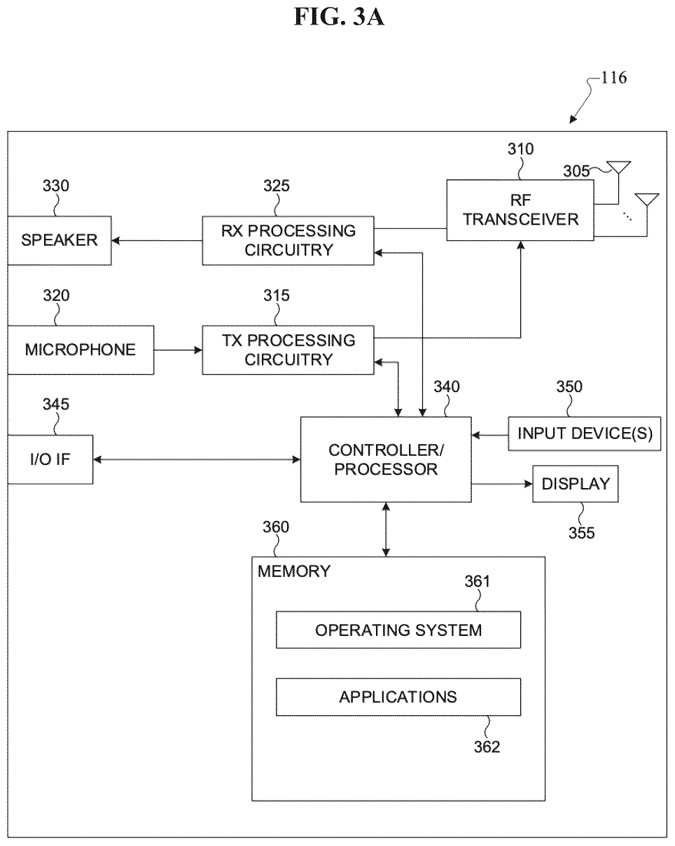

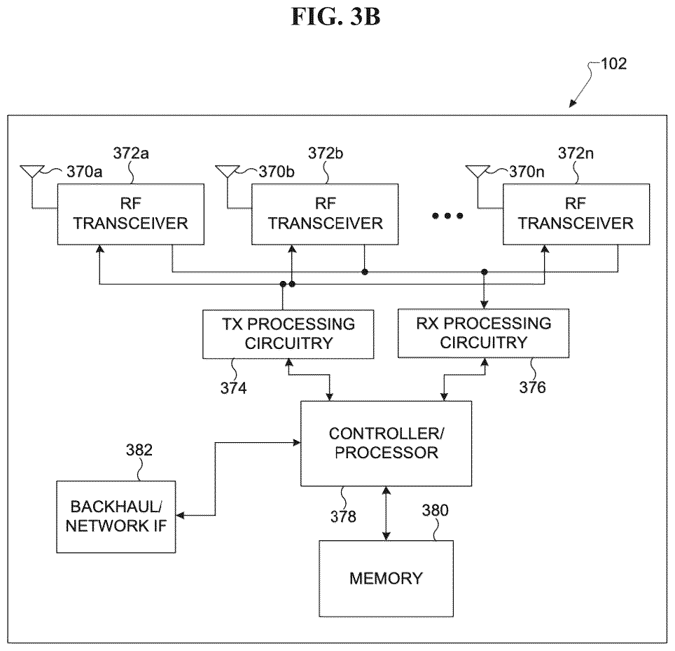

FIG. 3A illustrates an example UE 116 according to this disclosure. The embodiment of the UE 116 illustrated in FIG. 3A is for illustration only, and the UEs 111-115 of FIG. 1 can have the same or similar configuration. However, UEs come in a wide variety of configurations, and FIG. 3A does not limit the scope of this disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by an gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations for channel quality measurement and reporting for systems having 2D antenna arrays as described in embodiments of the present disclosure as described in embodiments of the present disclosure. The main processor 340 can move data into or out of the memory 360 as required by an executing process. In some embodiments, the main processor 340 is configured to execute the applications 362 based on the OS program 361 or in response to signals received from gNBs or an operator. The main processor 340 is also coupled to the I/O interface 345, which provides the UE 116 with the ability to connect to other devices such as laptop computers and handheld computers. The I/O interface 345 is the communication path between these accessories and the main controller 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites. The memory 360 is coupled to the main processor 340. Part of the memory 360 can include a random access memory (RAM), and another part of the memory 360 can include a Flash memory or other read-only memory (ROM).

Although FIG. 3A illustrates one example of UE 116, various changes may be made to FIG. 3A. For example, various components in FIG. 3A can be combined, further subdivided, or omitted and additional components can be added according to particular needs. As a particular example, the main processor 340 can be divided into multiple processors, such as one or more central processing units (CPUs) and one or more graphics processing units (GPUs). Also, while FIG. 3A illustrates the UE 116 configured as a mobile telephone or smartphone, UEs can be configured to operate as other types of mobile or stationary devices.

FIG. 3B illustrates an example gNB 102 according to this disclosure. The embodiment of the gNB 102 shown in FIG. 3B is for illustration only, and other gNBs of FIG. 1 can have the same or similar configuration. However, gNBs come in a wide variety of configurations, and FIG. 3B does not limit the scope of this disclosure to any particular implementation of an gNB. It is noted that gNB 101 and gNB 103 can include the same or similar structure as gNB 102.

As shown in FIG. 3B, the gNB 102 includes multiple antennas 370a-370n, multiple RF transceivers 372a-372n, transmit (TX) processing circuitry 374, and receive (RX) processing circuitry 376. In certain embodiments, one or more of the multiple antennas 370a-370n include 2D antenna arrays. The gNB 102 also includes a controller/processor 378, a memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 can control the reception of forward channel signals and the transmission of reverse channel signals by the RF transceivers 372a-372n, the RX processing circuitry 376, and the TX processing circuitry 374 in accordance with well-known principles. The controller/processor 378 can support additional functions as well, such as more advanced wireless communication functions. For instance, the controller/processor 378 can perform the blind interference sensing (BIS) process, such as performed by a BIS algorithm, and decodes the received signal subtracted by the interfering signals. Any of a wide variety of other functions can be supported in the gNB 102 by the controller/processor 378. In some embodiments, the controller/processor 378 includes at least one microprocessor or microcontroller.

The controller/processor 378 is also capable of executing programs and other processes resident in the memory 380, such as a basic OS. The controller/processor 378 is also capable of supporting channel quality measurement and reporting for systems having 2D antenna arrays as described in embodiments of the present disclosure. In some embodiments, the controller/processor 378 supports communications between entities, such as web RTC. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 can support communications over any suitable wired or wireless connection(s). For example, when the gNB 102 is implemented as part of a cellular communication system (such as one supporting 5G, LTE, or LTE-A), the interface 382 can allow the gNB 102 to communicate with other gNBs over a wired or wireless backhaul connection. When the gNB 102 is implemented as an access point, the interface 382 can allow the gNB 102 to communicate over a wired or wireless local area network or over a wired or wireless connection to a larger network (such as the Internet). The interface 382 includes any suitable structure supporting communications over a wired or wireless connection, such as an Ethernet or RF transceiver.

The memory 380 is coupled to the controller/processor 378. Part of the memory 380 can include a RAM, and another part of the memory 380 can include a Flash memory or other ROM. In certain embodiments, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

As described in more detail below, the transmit and receive paths of the gNB 102 (implemented using the RF transceivers 372a-372n, TX processing circuitry 374, and/or RX processing circuitry 376) support communication with aggregation of FDD cells and TDD cells.

Although FIG. 3B illustrates one example of an gNB 102, various changes may be made to FIG. 3B. For example, the gNB 102 can include any number of each component shown in FIG. 3. As a particular example, an access point can include a number of interfaces 382, and the controller/processor 378 can support routing functions to route data between different network addresses. As another particular example, while shown as including a single instance of TX processing circuitry 374 and a single instance of RX processing circuitry 376, the gNB 102 can include multiple instances of each (such as one per RF transceiver).

Rel.13 LTE supports up to 16 CSI-RS antenna ports which enable a gNB to be equipped with a large number of antenna elements (such as 64 or 128). In this case, a plurality of antenna elements is mapped onto one CSI-RS port. Furthermore, up to 32 CSI-RS ports will be supported in Rel.14 LTE. For next generation cellular systems such as 5G, it is expected that the maximum number of CSI-RS ports remain more or less the same. For example, Rel.15 NR can support up to 32 CSI-RS ports.

For mm Wave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies).

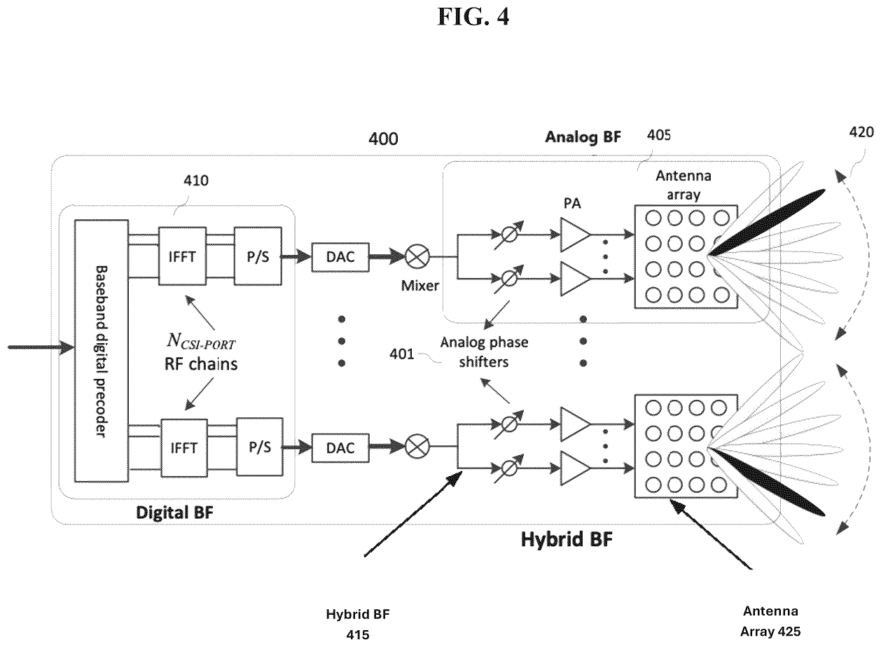

FIG. 4 illustrates a beamforming architecture 400 in accordance an embodiment. The embodiment of the beamforming architecture 400 illustrated in FIG. 4 is for illustration only. FIG. 4 does not limit the scope of the disclosure to any particular beamforming architecture. In at least one embodiment, one or more of gNB 102 or UEs 111-116 can include the beamforming architecture 400. In some embodiments, the beamforming architecture 400 includes analog phase shifters 401, an analog beamform (BF) 405, a digital BF 410, a hybrid BF 415, and one or more antenna arrays 425. In one example, one CSI-RS port is mapped onto a large number of antenna elements in antenna arrays 425, which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes or slots (wherein a subframe or a slot comprises a collection of symbols and/or can comprise a transmission time interval). The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks.

In at least some embodiments, the beamforming architecture 400 can be implemented in multi-user multiple-input multiple-output (MU-MIMO) operations—e.g., a class of wireless technology that enables a single access point (AP) or gNB to communicate with multiple devices (e.g., multiple UEs 111-116) simultaneously. In some embodiments, the beamforming architecture 400 can multiplex transmission of multiple data streams (e.g., layers) using spatial multiplexing (SM) on the same resources, resulting in an increase in the spectral efficiency (SE) per resource element. In some embodiments, the beamforming architecture 400 can perform MU-MIMO operations utilizing digital beamforming 410, analog beamforming 405, hybrid beamforming 415, or any combination thereof.

For example, the digital beamforming 410 can utilize zero-forcing (ZF) to improve the signal-to-interference ratio (SIR). In some embodiments, the digital beamforming 410 can utilize channel state information (CSI) reference signals (RS) to determine beam weights. For example, a gNB can estimate downlink channel quality from an uplink signal (e.g., from a sound referencing signal (SRS)) and select the best codebook matrix for a downlink transmission or the gNB can estimate the downlink quality from the CSI report from a UE 111 and select the best codebook matrix for downlink transmission accordingly. Additionally, the digital beamforming 410 can use a precoding matrix indicator (PMI) that includes information like beam selection (e.g., indices that select beams), beam amplitudes, phase information, and wideband and subbanding information. In other examples, the digital beamforming 410 could utilize a different technique (e.g., transmit antenna select (TAS) mode).

In at least some embodiments, the digital beamforming 410 can have difficulty gathering CSI information. That is, the digital beamforming 410 can have difficulty determining CSI information from channel state information reference signals (CSI-RS) measurements followed by CSI-RS reports or sound referencing signals (SRS). In some embodiments, these signals use resource elements and result in overhead.

In other embodiments, the beamforming architecture 400 is utilized in higher frequency bands (e.g., frequency bands greater than 52.6 GHZ). In such embodiments, the beamforming architecture 400 may utilize only analog beams. That is, in some higher frequencies SRS signals are not available to use for channel estimation. Accordingly, the beamforming architecture 400 can suffer reduced performance with bad channel estimates if using digital beamforming 410. Additionally, the digital beamforming 410 may use online computation, which can slow down performance in some cases. In such wireless systems, the gNB can transmit CSI-RS resources, each precoded with an analog beam, and the UE 111-116 measures the reference signals (RS) and identifies the best CSI-RS resource index. In at least one embodiment, the UE 111-116 can transmit the best CSI-RS index with the gNB via a beam measurement report and determine the best analog beam to serve UE 111. In such systems, though, the gNB can enable MU-MIMO if the gNB can operate in MU-MIMO mode with only beam index information.

However, as described above, beam management is an important and required procedure in mmWave frequencies. In some embodiments, in MU-MIMO operations, the beaming architecture 400 can transmit two or more beams simultaneously to two or more users (e.g., two UEs 111 and 112) if the two beams do not interfere with each other. That is, beamforming architecture 400 can disable the MU-MIMO and serve the users one at a time using time division multiple access (TDMA) when interference between a first beam directed at a first user and a second beam directed at a second user is high. Because MU-MIMO operations increase spectral efficiency and lead to a higher signal-to-interference-plus-noise ratio (SINR), it is important to have low interference and avoid performing TDMA operations.

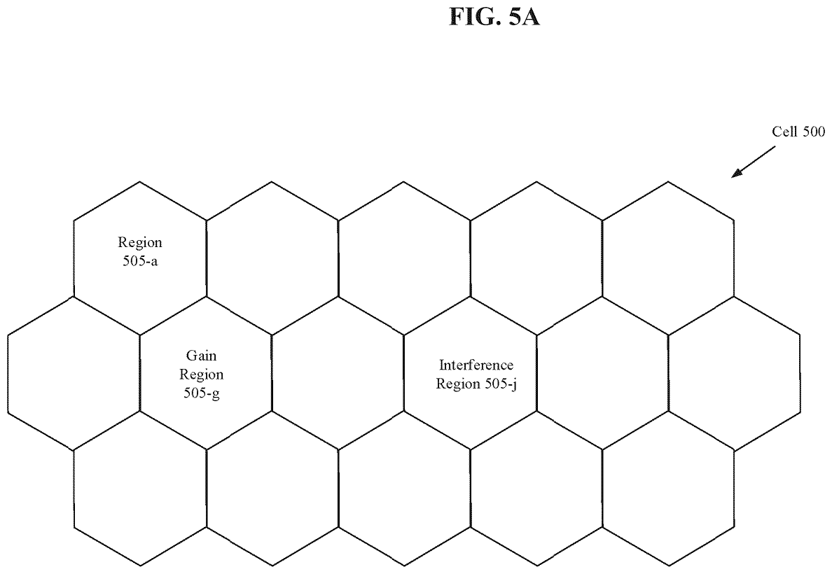

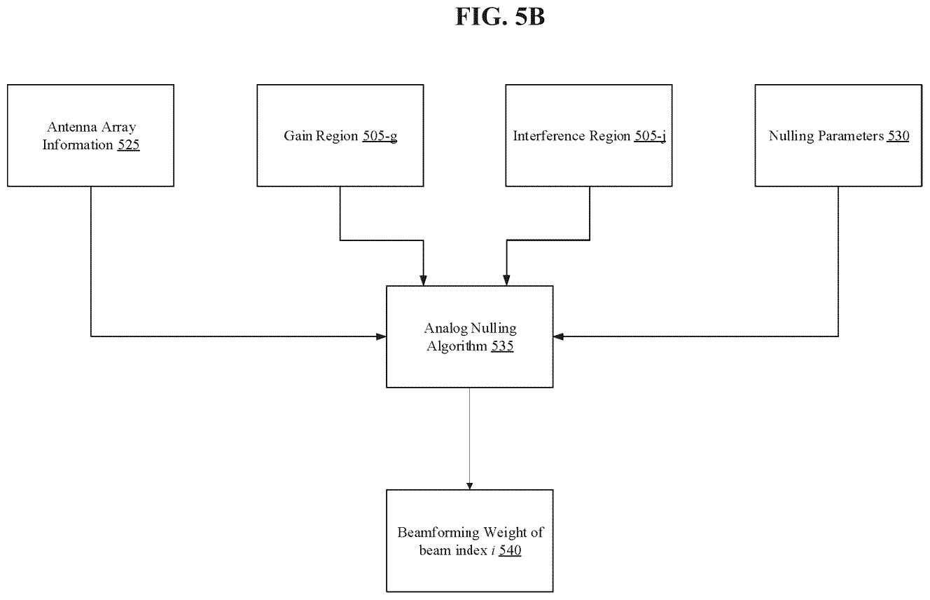

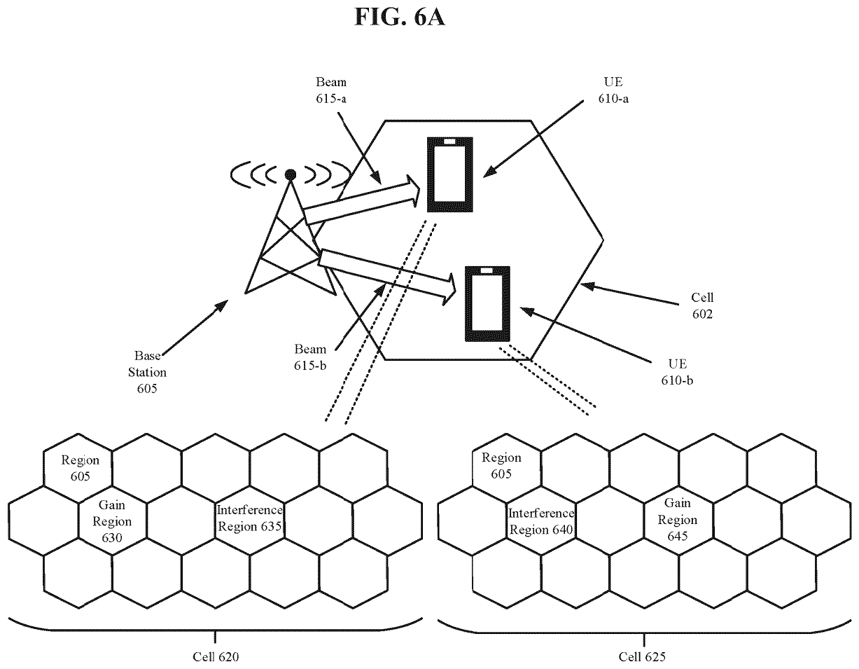

In conventional wireless systems, the beamforming architecture 400 can determine whether to perform a MU-MIMO operation based on a minimum signal-to-interference ratio (SIR) between the first and second beam. For example, the beamforming architecture 400 can determine beam alignment using a current beambook or codebook—e.g., determine a beam weight for the first beam and the second beam using the codebook. In such examples, the beamforming architecture 400 can compute the SIR between the first beam and the second beam. In some examples, the beamforming architecture 400 can determine the SIR of the first beam and the second beam exceeds an SIR threshold and perform a MU-MIMO operation. In other examples, the beamforming architecture 400 can determine the first beam and second beam fail to satisfy (e.g., are below) the SIR threshold and perform a TDMA operation accordingly. However, determining the beam alignment using the beambook or codebook can fail to account for interference regions generated by the first beam and the second beam. This leads to greater interference between the first beam and the second beam, reducing MU-MIMO opportunities and operations, and hurting the overall performance of the system. To reduce interference between the first beam and the second beam, the beamforming architecture 400 can utilize an analog null algorithm as described with reference to FIGS. 5-18. By utilizing the analog null algorithm, the beamforming architecture 400 can avoid channel estimations, online computations, and utilize a P-2 beam tracking procedure. In some embodiments, the analog null algorithm increases MU-MIMO opportunities and increases the overall spectral efficiency of the wireless system.

FIG. 5A illustrates a cell 500 in an example wireless system implementing an analog beam nulling for multi-user multiple-input multiple-output (MU-MIMO) according to embodiments of the present disclosure. In at least one embodiment, FIG. 5A illustrates a cell 500 (e.g., a cell sector or coverage area 120 or coverage area 125 as described with reference to FIG. 1). In some embodiments, a gNodeB (e.g., gNB 101, gNB 102, or gNB 103 as described with reference to FIG. 1) can provide wireless access to a network to user equipment (e.g., UE 111-UE 116 as described with reference to FIG. 1) located in the cell 500. In at least one embodiment, the cell 500 can include regions 505 (e.g., regions located within the cell 500). The hexagonal regions 505 are shown as approximately hexagonal for the purposes of illustration and explanation only. In some embodiments, the cell 500 may have other shapes, including irregular shapes, depending on the configuration of the gNB servicing the cell 500 and other variations in the radio environment associated with natural and man-made obstructions.

In some examples, the cell 500 illustrates a desired gain region 505-g. In some embodiments, the gain region 505-g is associated with a first UE—e.g., a first user is using the first UE in the location represented by gain region 505-g. In some embodiments, the cell 500 also illustrates an interference region 505-j. In at least one embodiment, the interference region 505-j is associated with a second UE—e.g., a second user is using the second UE in the location represented by gain region 505-j. In some embodiments, the first user is using the first UE and the second user is using the second UE simultaneously. As described herein, in such embodiments, the gNB (e.g., or a beamforming architecture 400 as described with reference to FIG. 4) performs a MU-MIMO operation to transmit data simultaneously to the first UE and the second UE.

For example, the gNB associated with cell 500 determines to service the first UE located in the gain region 505-g. In such embodiments, the gNB is configured to maximize a gain of a first beam transmitted to the first UE. That is, the gNB wants a gain of the first beam to be maximized for the first UE in the gain region 505-g. However, the gNB can also determine to service the second UE located in the interference region 505-j. In such embodiments, the gNB is also configured to maximize a gain of a second beam transmitted to the second UE. That is, the gNB wants a gain of the second beam maximized for the second UE in the interference region 505-j. As described above, the gNB can perform a MU-MIMO operation when there is low interference between the first beam and the second beam. To reduce interference between the two beams, the gNB can utilize an analog nulling algorithm 535 as described with reference to FIG. 5B.

For example, the gNB can determine the first beamforming weight of the first beam by utilizing the gain region 505-g in addition to the interference region 505-j. That is, the gNB determines the first beam should have a maximum gain at the gain region 505-g (e.g., so that a signal is received at the first UE) but a minimum gain at the interference region 505-j (e.g., so that the signal received at the first UE does not interfere with or otherwise disrupt a second signal received at the second UE). Accordingly, the gNB can utilize the analog nulling algorithm 535 in order to maximize the gain at the gain region 505-g and minimize the gain at the interference region 505-j for the first beam.

In one embodiment, the gNB using the analog nulling algorithm 535 utilizes the intended gain region 505-g and the undesired interference region 505-j as inputs and determines an optimized beamforming weight as an output. For example, the gNB can input antenna array information 525 into the analog nulling algorithm 535. In some embodiments, the antenna array information 525 includes at least one of antenna element locations, antenna element gains, array response vectors, a number of phase shifter bits (e.g., phase shifter bits 401 as described with reference to FIG. 4), and/or a phase shifter resolution. In at least one embodiment, the gNB transmits a beam generated by the analog nulling algorithm by adjusting the analog phase shifters based on the array information 525. In at least one embodiment, the gNB inputs gain region 505-g information (e.g., location or coordinates associated with the first UE) into the analog nulling algorithm 535. In at least one embodiment, the analog nulling algorithm 535 is designed to maximize a gain of the first beam in the gain region 505-g. In at least one embodiment, the gNB inputs interference region 505-j information into the analog nulling algorithm 535. In at least one embodiment, the interference region 505-j indicates a location or coordinate of a second UE. In at least one embodiment, the analog nulling algorithm 535 is designed to minimize a gain of the first beam in the interference region 505-j. In some embodiments, the gNB provides nulling parameters 530 to the analog nulling algorithm 535. In at least one example, the nulling parameters 530 include a loss function (e.g., a signal-to-leakage ratio (SLR), a signal-to-interference ratio (SIR), a signal-to-interference-plus-noise ratio (SINR), etc.), a max iteration number to stop, optionally include initial weights of a beam index (e.g., of a beam index “i”, w⁽ⁱ⁾, where the beam index refers to a specific beam direction, used by the first UE), or optionally include an importance (weights) of each direction. In at least one embodiment, the analog nulling algorithm 535 utilizes a signal-to-leakage ratio (SLR) as the loss function. In such embodiments, the analog nulling algorithm 535 optimizes the SLR by maximizing the gain in the gain region 505-g and minimizing the gain in the interference region 505-j. In at least one embodiment, utilizing the analog nulling algorithm 535 can improve the SIR of MU-MIMO operations—e.g., a group of beams transmitted in the MU-MIMO operation can be designed to be maximize the beam gain for each desired gain region and minimize the beam gain for each undesired interference region. In at least one embodiment, the analog nulling algorithm 535 can take the antenna array information 525, the gain region 505-g information, the interference region 505-j information, and the nulling parameters 530 to determine a beamforming weight of beam index “i” 540.

In some embodiments, the analog nulling algorithm 535 uses a modified concave utility function to generate the beamforming weight 540. In such embodiments, the gNB or UE samples an angular direction (θ,φ) from the gain region 505-g and also samples an angular direction (θ,φ) from the interference region 505-j. In at least one embodiment, a beam gain pattern of a beam with weights w in the direction (θ,φ), can be expressed by equation (1):

$$P ( θ , φ ) = p ( θ , φ ) {w}^{H} a ( θ , φ ) {a ( θ , φ )}^{H} w , \qquad ( 1 )$$

where a(θ,φ) is the array response vector and p(θ,φ) is the antenna element pattern in the direction (θ,φ). In at least one embodiment, w^{H} denotes a complex conjugate transpose of the weight vector w and a(θ,φ)^{H} denotes the complex conjugate transpose of the array response vector a(θ,φ). In at least one embodiment, beam nulling algorithm 535 is designed to maximize the sum of the concave utility function of the beamforming gain in the gain region 505-g while minimizing the sum of the concave utility function of the beamforming gain in the interference region 505-j, as expressed by equation (2):

$$max {w}^{( i )} ( {\sum }_{( θ , φ ) ϵ {G}_{i}} f ( p ( θ , φ ) {w}^{( i ) H} a ( θ , φ ) a ( θ , φ ) {a ( θ , φ )}^{H} {w}^{( i )} ) - {\sum }_{( θ , φ ) ϵ {L}_{i}} f ( p ( θ , φ ) {w}^{{( i )}^{H}} a ( θ , φ ) {a ( θ , φ )}^{H} {w}^{( i )} ) ) \qquad ( 2 )$$

where Gᵢ is the gain region 505-g and Lᵢ is the interference avoidance region 505-j. In at least one embodiment, equation (2) utilizes a function ƒ(x) is a concave utility function. In one example, the utility function ƒ(x) could be set as log(x). In at least one embodiment, the optimization utility function ƒ(x) is utilized to maintain a high average gain, relax high peaks, and reduce leakage. In such examples, the utility function ƒ(x) can be used to minimize the mean squared error. For example, the utility function ƒ(x) for each region 505 can be expressed by equation (3):

$$- {( log ( g ( \vec{w} , {φ}_{i} , {θ}_{i} ) ) - {T}_{\frac{H}{L}} )}^{2} \qquad ( 3 )$$

where g is the gain in the (\vec{w},φᵢ,θᵢ) direction and T_{H} is target threshold for the gain within the region Gᵢ and T_{L} is a target threshold for the low leakage within the leakage avoidance region Lᵢ, where the high threshold is determined by obtaining a beam pattern G₀(θ,φ) and expressing T_{high} by equation (4):

$$log {T}_{high} = E \{ log ( {G}_{0} ( θ , φ ) ) \} \qquad ( 4 )$$

and T_{low} is set to a small nominal value (positive or negative)—e.g., while the desired interference is 0, this would cause T_{low} to be infinitely negative (e.g., −∞). In at least one embodiment, the utility function equation (2) can be solved or optimized with a cyclic coordinate descent algorithm—e.g., the cyclic coordinate descent algorithm sequentially updates beamforming weights. For example, if we assume there are K antenna elements, the coordinate descent algorithm would first optimize

$${w}_{0}^{( i )}$$

while the remaining weights are unchanged. After optimizing

$${w}_{0}^{( i )} ,$$

the cyclic coordinate descent algorithm optimizes

$${w}_{1}^{( i )} , {w}_{2}^{( i )} , {w}_{3}^{( i )} , … , {w}_{K - 1}^{( i )} ,$$

then back to optimizing

$${w}_{0}^{( i )} ,$$

eventually stopping when the cyclic coordinate descent algorithm converges to a local optimal w⁽ⁱ⁾.

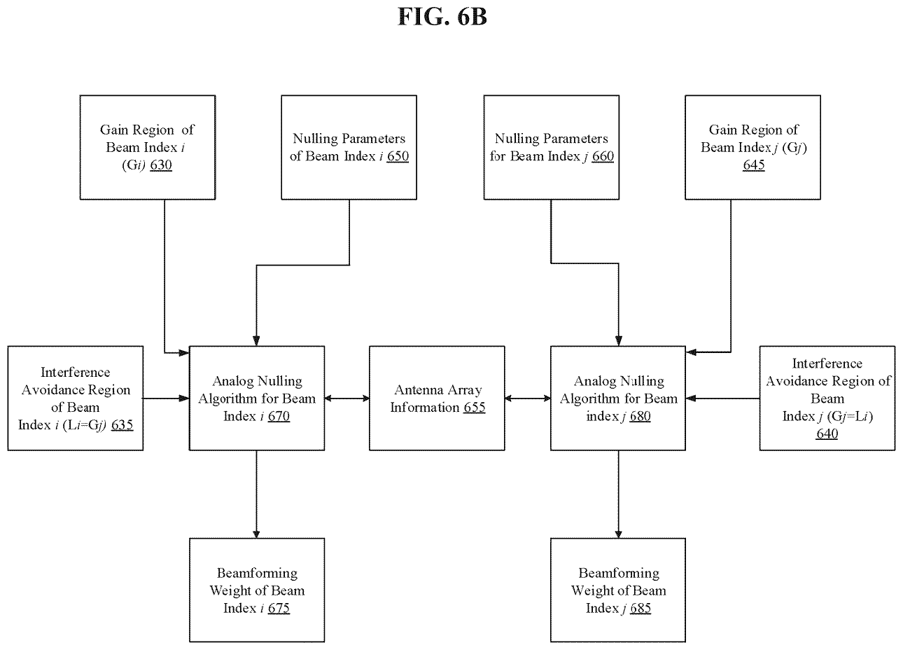

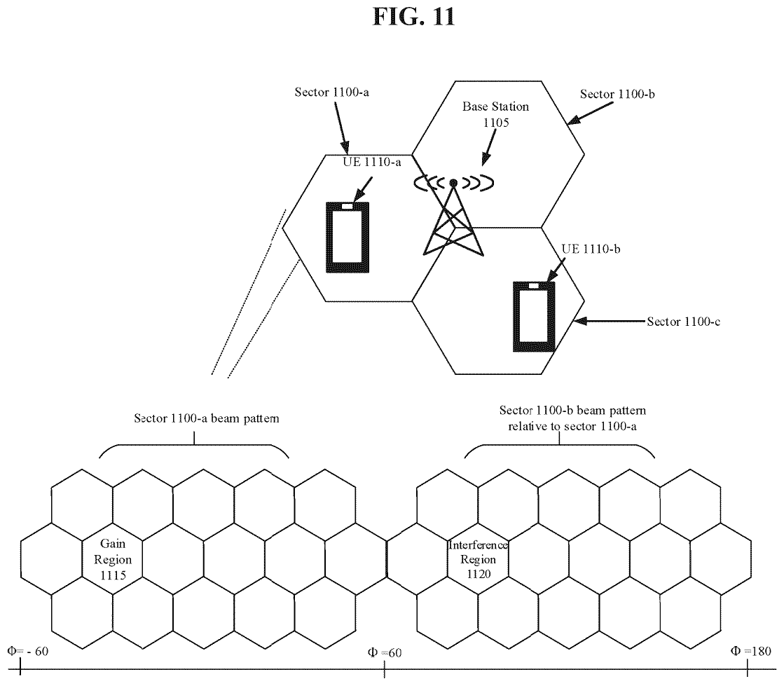

It should be noted that the analog nulling algorithm 535 being utilized in mmWave bands (e.g., by adjusting the phase shifter 401 values) is for illustrative purposes and explanation only. Other embodiments of the analog nulling algorithm 535 can be utilized in other frequency bands (e.g., in 6G). Additionally, mathematical representations of the analog nulling algorithm 535 are shown for illustrative and explanatory purposes only. Other mathematical models and equations can be used for the analog nulling algorithm 535—e.g., any mathematical model that maximizes the gain in the gain region 505-g and the minimizes the gain in the interference region 505-j. In at least some embodiments, the beam nulling algorithm 535 is used for reducing intra-cell (e.g., within cell 500) interference. In such examples, the beam nulling algorithm 535 can be used to increase the SIR in MU-MIMO operations as well as increasing the opportunities for performing MU-MIMO operations. In at least one embodiment, intra-cell embodiments are discussed with reference to FIGS. 6-10. In at least one embodiment, beam nulling algorithm 535 is used for inter-cell interference—e.g., between cell 500 and another cell. In such embodiments, the beam nulling algorithm 535 can reduce interference between cells that are co-located (e.g., adjacent to one another) and cells that are non-co-located. In at least one embodiment, cells are co-located if they are served by a same gNB and are non-co-located if they are served by different gNBs. In at least one embodiment, inter-cell embodiments are discussed with reference to FIGS. 11-17.

FIG. 6A illustrates an example wireless system 600 implementing an analog beam nulling for MU-MIMO according to embodiments of the present disclosure. In at least one embodiment, FIG. 6 illustrates a cell 602 (e.g., a cell 500 or coverage area 120 or coverage area 125 as described with reference to FIGS. 1 and 5). In some embodiments, the wireless system includes a base station (BS) 605 (e.g., a gNB node 101 as described with reference to FIG. 1). In some embodiments, the BS 605 can provide wireless access to a network for user equipment (UE) 610-a and UE 610-b (e.g., UE 111-UE 116 as described with reference to FIG. 1) located in the cell 602. In at least one embodiment, the cell 602 includes regions 605 (e.g., regions located within the cell 602). The hexagonal regions 605 are shown as approximately hexagonal for the purposes of illustration and explanation only. In some embodiments, the cell 602 may have other shapes, including irregular shapes, depending on the configuration of the gNB servicing the cell 602 and other variations in the radio environment associated with natural and man-made obstructions.

In at least one embodiment, FIG. 6 illustrates a base station 605 performing a MU-MIMO operation with respect to UE 610-a and 610-b. For example, the BS 605 transmits beam 615-a to UE 610-a and transmits beam 615-b to UE 610-b simultaneously, at least in part. In one embodiment, cell 620 illustrates a beam pattern for the first beam 615-a and cell 625 illustrates a beam pattern for the second beam 615-b. For example, cell 620 illustrates a gain region 630 and an interference region 635. In some embodiments, the cell 620 illustrates that a UE 610-a serviced by the first beam 615-a is located in the gain region 630 and the UE 610-b serviced by the second beam is located in the interference region 635—e.g., that is the first beam 615-a is designed to optimize a maximum gain in the gain region 630 while minimizing the gain in the interference region 635. In some embodiments, the second beam 615-b has an interference region 640 and a gain region 645 as illustrated in cell 625. Importantly, the second beam 615-b gain region (e.g., gain region 645) is also the interference region 635 with respect to the first beam 615-a and the first beam 615-a gain region (e.g., gain region 630) is also the interference region 640 with respect to the second beam 615-b. Accordingly, the first beam 615-a is designed using the analog nulling algorithm (e.g., analog nulling algorithm 535 as described with reference to FIG. 5B) to maximize its gain in gain region 630 and minimize its gain in the interference region 635 while the second beam 615-b is designed to maximize its gain in the gain region 645 and minimize its gain in the interference region 640. In some embodiments, because the first beam 615-a gain region 630 is the same as the second beam 615-b interference region 640, the first beam 615-a is maximized at gain region 630 while the second beam 615-b is minimized at the gain region 630, reducing overall interference between the first beam 615-a and the second beam 615-b with respect to UE 610-a. Similarly, because the second beam 615-b gain region 645 is the same as the first beam 615-a interference region 635, the second beam 615-b is maximized at the gain region 645 while the first beam 615-a is minimized at the gain region 645, reducing the overall interference between the first beam 615-a and the second beam 615-b with respect to UE 615-b. Accordingly, the wireless system 600 can proceed with a MU-MIMO operation and service both UE 610-a and UE 610-b by designing the first beam 615-a and second beam 615-b using the analog nulling algorithm.

In at least one embodiment, FIG. 6B illustrates an example of determining the beamforming weights of the first beam 615-a and the second beam 615-b using the analog nulling algorithm. In at least one embodiment, the base station 605 determines a first beam index associated with the first beam 615-a and a second beam index associated with the second beam 615-b. In one example, the base station 605 determines the first beam index i and the second beam index j for the first beam 615-a and the second beam 615-b, respectively. Accordingly, the base station 605 can determine a first beamforming weight for the beam index i and determine a second beamforming weight for the beam index j.

For example, the base station 605 can utilize the analog nulling algorithm 670 for the first beam index, beam index i. In such examples, the base station 605 determines a gain region and an interference region for the first beam index. In one embodiment, the base station 605 determines a gain region 630 (G;) and an interference avoidance region 635 (Lt) for the first beam index. As described with reference to FIG. 6A, the base station 605 can set the gain region (e.g., gain region 645) of the second beam index as the interference avoidance region (e.g., interference avoidance region 635) of the first beam index. In that, the gain region of the second beam is equal to the interference region of the first beam—e.g., Gⱼ=Lᵢ. In at least one embodiment, the base station 605 can also input nulling parameters of beam index i 650. In some embodiments, the nulling parameters of beam index i 650 can include at least one of a loss function, a max iteration, initial weight(s) of beam index i (wⁱ), and/or an importance (weights) of each direction of beam index i. In at least one embodiment, the base station 605 also inputs antenna array information 655 (e.g., antenna element locations, antenna element gain, array response vector, and a number of phase shifter bits). In at least one embodiment, the base station 605 is configured to design a beamforming weight of beam index i that optimizes a gain at the gain region 630 and minimizes a gain at interference region 635 based on the nulling parameters 650 and antenna array information 655. For example, the base station 605 can design the beamforming weight of beam index i to optimize a signal-to-interference ratio (SIR) of the first user in a MU-MIMO mode. In at least one embodiment, the base station 605 can follow a similar process to design the beamforming weight of beam index j.

For example, the base station 605 determines a gain region 645 (Gⱼ) and an interference avoidance region 640 (Lⱼ) for the first beam index. As described with reference to FIG. 6A, the base station 605 can set the gain region (e.g., gain region 630) of the first beam index as the interference avoidance region (e.g., interference avoidance region 640) of the second beam index. In that, the gain region of the first beam is equal to the interference region of the second beam—e.g., Gᵢ=Lⱼ. In at least one embodiment, the base station 605 can also input nulling parameters of beam index j 660. In some embodiments, the nulling parameters of beam index j 660 can include at least one of a loss function, a max iteration, initial weight(s) of beam index j (w^{j}), and/or an importance (weights) of each direction of beam index j. In at least one embodiment, the base station 605 also inputs antenna array information 655 (e.g., antenna element locations, antenna element gain, array response vector, and a number of phase shifter bits). In at least one embodiment, the base station 605 is configured to design a beamforming weight of beam index j that optimizes a gain at the gain region 645 and minimizes a gain at interference region 640 based on the nulling parameters 660 and antenna array information 655. For example, the base station 605 can design the beamforming weight of beam index j to optimize a signal-to-interference ratio (SIR) of the second user in a MU-MIMO mode. By designing the first beam 615-a and the second beam 615-b to take the interference avoidance region of the other beam into account, the overall SIR of the first user and second user is reduced and the MU-MIMO operation can be utilized.

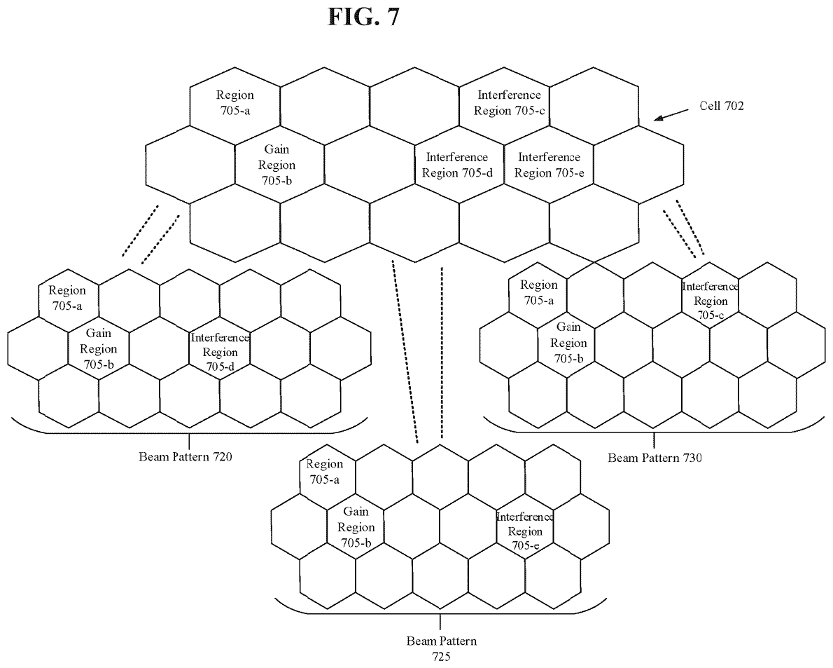

FIG. 7 illustrates a wireless system 700 that implements analog beam nulling for MU-MIMO according to embodiments of the present disclosure. In at least one embodiment, FIG. 7 illustrates a cell 702 (e.g., a cell 500 or coverage area 120 or coverage area 125 as described with reference to FIGS. 1 and 5). In some embodiments, a gNodeB (e.g., gNB 101, gNB 102, or gNB 103 as described with reference to FIG. 1) provides wireless access to a network for user equipment (e.g., UE 111-UE 116 as described with reference to FIG. 1) located in the cell 702. In at least one embodiment, the cell 702 includes regions 705 (e.g., regions located within the cell 702). The hexagonal regions 702 are shown as approximately hexagonal for the purposes of illustration and explanation only. In some embodiments, the cell 702 may have other shapes, including irregular shapes, depending on the configuration of the gNB servicing the cell 702 and other variations in the radio environment associated with natural and man-made obstructions.

In at least one embodiment, wireless system 700 is an example of three or more UE devices being located in a same cell 702. For example, gain region 705-b represents a location of a first UE. In some embodiments, interference region 705-c represents a location of a second UE, interference region 705-d represents a location of a third UE, and interference region 705-c represents a location of a fourth UE. In some embodiments, the gNB or the wireless system 700 designs a beam index i that is designed to have low interference with multiple other beams (e.g., beam index j, beam index k, beam index/, etc.). In at least one embodiment, the wireless system 700 designs the beam index i with respect to each other beam index. For example, the beam index i is associated with the gain region 705-b, beam index j is associated interference region 705-d, beam index k is associated with interference region 705-e and beam index/is associated with interference region 705-c. In such examples, the gNB can design beam index i with respect to the interference regions of beam index j, beam index k, beam index l. For example, the gNB designs a first beam weight w^{(i,j)} (illustrated by beam pattern 720) that maximizes a gain in gain region 705-b and minimizes the gain in interference region 705-d—e.g., the beam w^{(i,j)} reduces interference between beams i and j at the gain region 705-b and interference region 705-d. Similarly, the gNB designs a second beam weight w^{(i,k)} (illustrated by beam pattern 725) that maximizes a gain in gain region 705-b and minimizes the gain in interference region 705-c—e.g., the beam w^{(i,k)} reduces interference between beams i and k at the gain region 705-b and interference region 705-c. In some embodiments, the gNB further designs a third beam weight w^{(i,l)} (illustrated by beam pattern 730) that maximizes a gain in gain region 705-b and minimizes the gain in interference region 705-c—e.g., the beam w^{(i,l)} reduces interference between beams i and I at the gain region 705-b and interference region 705-c. In at least one embodiment, the gNB stores multiple copies of beam i, based on usage. For example, the gNB can store multiple copies of beam w^{(i,k)} if beam w^{(i,k)} is used frequently. By storing the beam weights, the gNB can reduce latency and utilize less resource overhead to calculate beam weights. In some embodiments, the gNB or network precomputes and stores low interference beam weights to reduce online computational demand—e.g., a beam management module can precompute the beam weights. In such embodiments, the gNB stores the precomputed beam weights and use the corresponding low-interference beamforming weight when servicing a respective user. In at least one embodiment, the gNB uses a hybrid system of storing frequently used low interference beamforming weights and computing least used weights online.

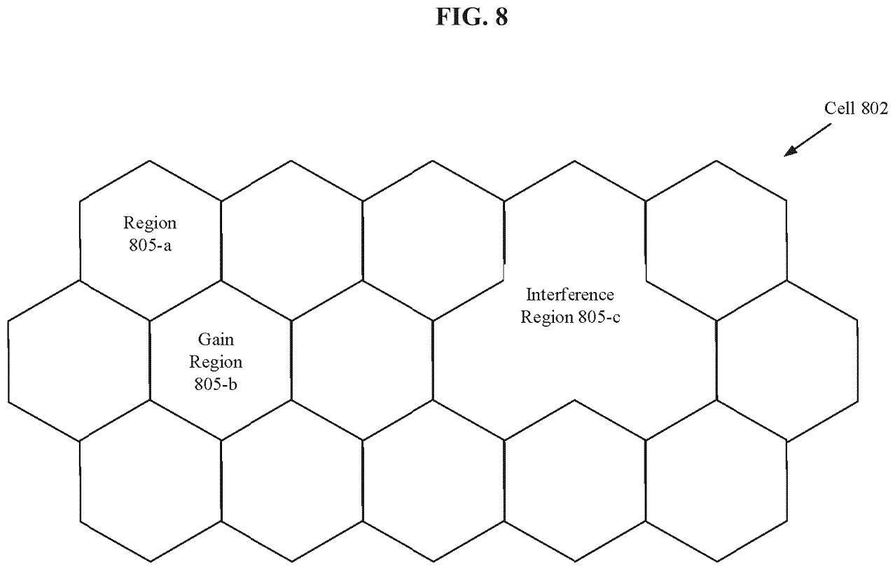

FIG. 8 illustrates a wireless system 800 that implements analog beam nulling for MU-MIMO according to embodiments of the present disclosure. In at least one embodiment, FIG. 8 illustrates a cell 802 (e.g., a cell 500 or coverage area 120 or coverage area 125 as described with reference to FIGS. 1 and 5). In some embodiments, a gNodeB (e.g., gNB 101, gNB 102, or gNB 103 as described with reference to FIG. 1) provides wireless access to a network for user equipment (e.g., UE 111-UE 116 as described with reference to FIG. 1) located in the cell 802. In at least one embodiment, the cell 802 includes regions 805 (e.g., regions located within the cell 802). The hexagonal regions 802 are shown as approximately hexagonal for the purposes of illustration and explanation only. In some embodiments, the cell 802 may have other shapes, including irregular shapes, depending on the configuration of the gNB servicing the cell 802 and other variations in the radio environment associated with natural and man-made obstructions.

In at least one embodiment, wireless system 800 is an example of three or more UE devices being located in a same cell 802. For example, gain region 805-b represents a location of a first UE. In some embodiments, interference region 805-c represents a location of a second UE, a location of a third UE, and a location of a fourth UE—e.g., there can be multiple UE devices in the interference region 805-c.

In some embodiments, the gNB or the wireless system 800 designs a beam index i that is designed to have low interference at a large interference region 805-c. In at least one embodiment, the wireless system 800 designs the beam index i by setting the interference region 805-c as a union of gain regions of every other beam. For example, the interference region 805-c illustrates a union of gain regions of every other beam—e.g., a union of beam index j associated with interference region 705-d, beam index k associated with interference region 705-e and beam index I is associated with interference region 705-c, where the combined interference regions 705-c, 705-d, and 705-e represent interference region 805-c (e.g., represent a gain region associated with beam index j, a gain region associated with beam index k, and a gain region associated with beam index l. In such examples, the gNB designs beam index i with respect to the entire interference region 805-c. For example, the gNB can design a first beam having a first weight, where the first beam maximizes the gain at gain region 805-b and minimizes gain at the interference region 805-c—e.g., minimizes the gain with respect to the union gain region of beam index j, beam index k, beam index l (e.g., collectively the interference region 805-c).

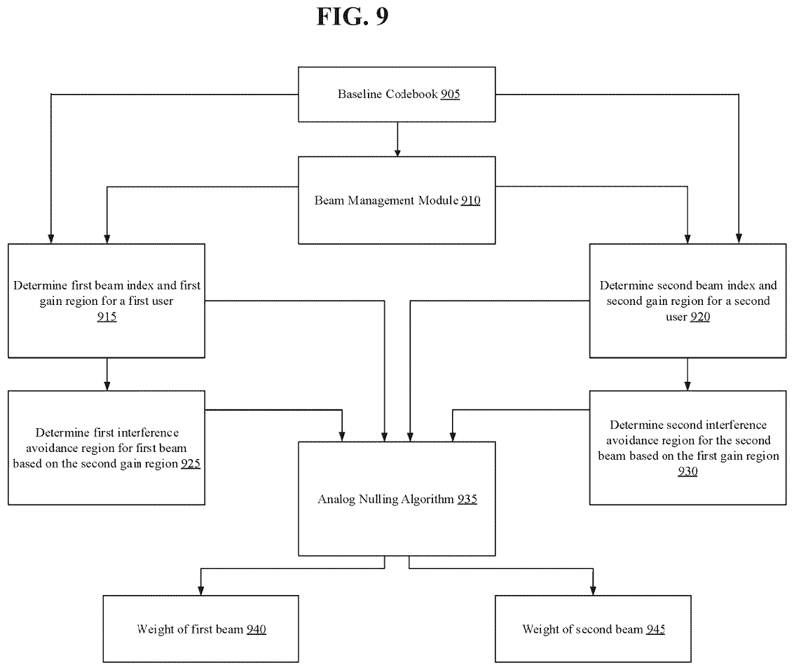

FIG. 9 illustrates a chart of an example process of analog beam nulling for MU-MIMO in accordance with an embodiment. Although one or more operations are described or shown in particular sequential order, in other embodiments the operations may be rearranged in a different order, which may include performance of multiple operations in at least partially overlapping time periods. In at least one embodiment, the chart illustrated by FIG. 9 corresponds to performing an initial beam management operation to get initial beam indices and weights before using the analog nulling algorithm.

At operation 905, a gNB (e.g., gNB 101, 102, or 103 as described with reference to FIG. 1) or user equipment (e.g., UE 111-116 as described with reference to FIG. 1) accesses a stored baseline codebook. In some embodiments, the codebook is an example of a Type I codebook, a Type II codebook, a Type II port selection codebook, an Enhanced Type II codebook, an Enhanced Type II Port selection codebook, a further enhanced Type II port selection codebook, or any other codebook as described in Rel. 15NR, Rel. 16NR, Rel. 17NR, and subsequently released codebooks.

At operation 910, a beam management module uses the baseline codebook (e.g., a baseline conventionally designed narrow beambook) to determine an initial beam index i and initial beam index j (e.g., beam index i and beam index j as described with reference to FIGS. 5-8). For example, the beam management module determines initial beam weights by determining or selecting information corresponding to a beam selection, a beam amplitude, phase information, wideband and subband reporting information, a precoding matrix indicator (PMI), spatial and frequency domains, etc. In other examples, the beam management module determines beam indices as described with reference to FIG. 4, e.g., the gNB can transmit CSI-RS resources, each precoded with an analog beam, and the UE 111-116 measures the reference signals (RS) and identifies the best CSI-RS resource index accordingly.

For example, at operation 915, the beam management module determines an initial first beam index (e.g., beam index i) and a corresponding first gain region (Gᵢ) for a first user. At process 920, the beam management module can determine a second beam index (e.g., beam index j) and a corresponding second gain region (Gⱼ).

In at least one embodiment, after the initial beam indices are determined (e.g., beam index i and beam index j), the gNB utilizes an analog nulling function (e.g., analog nulling function 535 as described with reference to FIG. 5). To use the analog nulling function, at operation 925, the gNB first determines a first interference avoidance region for the first beam. In some embodiments, the gNB can determine the first avoidance region based on the second gain region. That is, as described with reference to FIG. 6, the gain region of the second beam index can be used as the first interference avoidance region for the first beam index. In some embodiments, at operation 930, the gNB can determine a second interference avoidance region for the second beam. In at least one embodiment, the gNB can determine the second avoidance region based on the first gain region—e.g., the first gain region can be used as the second avoidance region with respect to the second beam index j.

At operation 935, the nulling algorithm receives the various inputs shown in FIG. 9 to determine and calculate a first beam weight and a second beam weight. For example, the gNB inputs the first beam index, the first gain region, and the first interference region, along with respective antenna array information (e.g., antenna array information 525 as described with reference to FIG. 5) and nulling parameters (e.g., nulling parameters 530 as described with reference to FIG. 5) to determine the first beam weight. In some embodiments, the gNB inputs the second beam index, the second gain region, and the second interference region, along with respective antenna array information and nulling parameters to determine the second beam weight.

At operation 940, the gNB determines the first beam weight (e.g., weight of a low interference beam i, having weight w^{(i,j)}. In some embodiments, the low interference beam i maximizes its gain in the first gain region and minimizes its gain in the first avoidance region.

At operation 945, the gNB determines the second beam weight (e.g., weight of a low interference beam j, having weight w^{(j,i)}. In at least some embodiments, the low interference beam j maximizes its gain in the second gain region and minimizes its gain in the second avoidance region. By utilizing the analog nulling algorithm, the gNB can service both the first user and the second user using a MU-MIMO operation as the first beam and the second beam have a low interference with respect to each other.

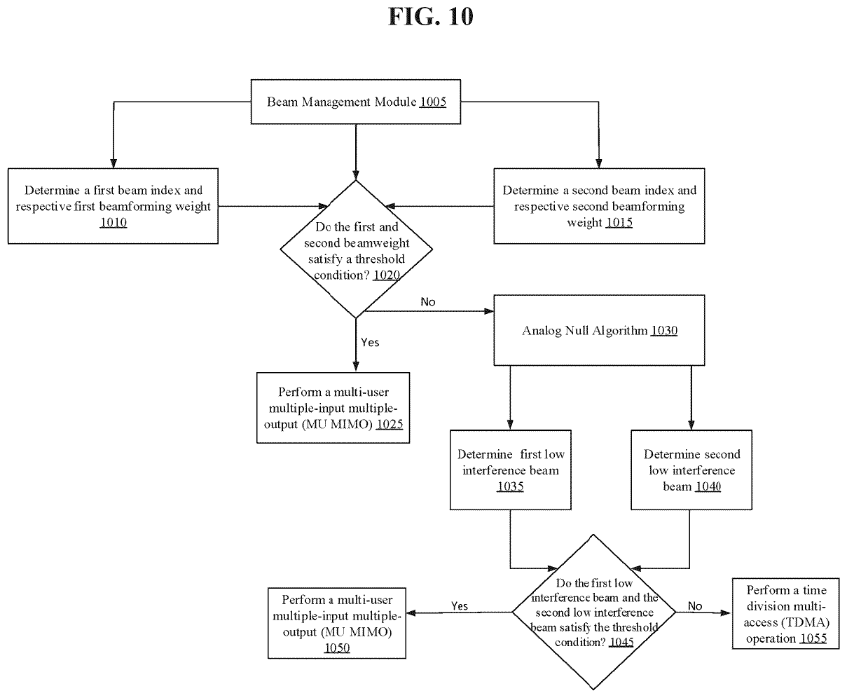

FIG. 10 illustrates a flow chart of an example process of analog beam nulling for MU-MIMO in accordance with an embodiment. Although one or more operations are described or shown in particular sequential order, in other embodiments the operations may be rearranged in a different order, which may include performance of multiple operations in at least partially overlapping time periods. In at least one embodiment, the chart illustrated by FIG. 10 corresponds to performing an initial beam management operation to get initial beam weights and before using the analog nulling algorithm to refine the beam weights.

At operation 1005, a beam management module 1005 determines initial beam indices and beamforming weights to serve one or more users. For example, the beam management module accesses a stored codebook (e.g., a baseline codebook as described with reference to FIG. 9). In other embodiments, the beam management module 1005 determines initial beam indices by having the gNB transmit CSI-RS resources, each precoded with an analog beam. In such embodiments, the UE 111-116 determines the reference signals (RS) and identifies the best CSI-RS resource index. In at least one embodiment, the UE 111-116 transmits the best CSI-RS index with the gNB via a beam measurement report and determine the best analog beam to serve UE 111. In other examples, the beam management module 1005 utilizes digital domain beamforming to determine the initial beam index and beamforming weights—e.g., perform CSI-RS measurements and receive CSO-RS reports in the digital domain.

For example, at operation 1010, the beam management module determines a first beam index (e.g., beam index i) and a respective first beamforming weight (e.g., c⁽ⁱ⁾) for a first user—e.g., the gNB determines a first user to service and determines the appropriate beam index and beamforming weight accordingly. In some embodiments, at operation 1015, the beam management module determines a second beam index (e.g., beam index j) and a respective second beamforming weight (e.g., c^{(j)} for a second user—e.g., the gNB determines a second user to service and determines the appropriate beam index and beamforming weight accordingly.

At operation 1020, the gNB (e.g., or beam management module) determines if the first and second beamforming weights satisfy a threshold condition. As described with reference to FIG. 4, the gNB can perform a MU-MIMO operation based on a minimum signal-to-interference ratio (SIR) between the first and second beam satisfying a threshold condition—e.g., the gNB can determine if the first beamforming weight and second beamforming weight satisfy an SIR threshold value (Γ). For example, the gNB can determine if a SIR^{(a,b)}(c⁽ⁱ⁾, c^{(j)})>Γ and whether SIR^{(b,a)}(c^{(j)},c⁽ⁱ⁾)>Γ, where a represents the SIR associated with the first user and the b represents the SIR associated with the second user. In at least one embodiment, the SIR is associated with the first user being served with the first beamforming weight, where the cause of interference is the associated with the second user being served with the second beamforming weight. In at least one embodiment, the gNB proceeds to operation 1025 if SIR^{(a,b)}(c⁽ⁱ⁾, c^{(j)})>Γ and SIR^{(b,a)}(c^{(j)},c⁽ⁱ⁾)>Γ. In other embodiments, the gNB proceeds to operation 1030 if SIR^{(a,b)}(c⁽ⁱ⁾,c^{(j)})<Γ and/or SIR^{(b,a)}(c^{(j)},c⁽ⁱ⁾)<Γ.

At operation 1025, the gNB performs a MU-MIMO operation with respect to the first user and the second user. That is, the gNB determines the first beamforming weight and the second beamforming weight satisfy the threshold criterion (e.g., there is low interference between the first beamforming weight and the second beamforming weight) and perform a MU-MIMO operation accordingly.

At operation 1030, the gNB utilizes the analog null algorithm to design a first low interference beam and a second low interference beam—e.g., the gNB can utilize the analog null algorithm to further reduce interference between a first beam serving the first user and a second beam serving the second user. In some embodiments, the gNB calculates the first low interference beam and second low interference beam utilizing operations 1035 and 1040. In other embodiments, the gNB accesses a storage location storing the first low interference beam and the second low interference beam. That is, as described with reference to FIG. 7, the gNB can store common low interference beam weights. For example, the gNB may have stored a first low interference beam (e.g., w^{(i,j)}) and a second low interference beam (e.g., w^{(j,i)}) based on previous MU-MIMO operations. In embodiments where the gNB access stored beam values, the gNB proceeds to operation 1045 without utilizing additional resources.

For example, at operation 1035, the gNB determines a first low interference beam (e.g., w^{(i,j)}). In at least one embodiment, to determine the first low interference beam, the gNB determines a first gain region associated with the first user. In some embodiments, the gNB also determines a first interference avoidance region associated with the second user. In at least one embodiment, the gNB determines the first interference region by determining a second gain region associated with the second user (e.g., as described with reference to FIG. 6, the gain region of the second beam can be set as the interference avoidance region of the first beam). In at least one embodiment, the gNB can also consider antenna array information (e.g., antenna array information 525 as described with reference to FIG. 5) and nulling parameters (e.g., nulling parameters 530 as described with reference FIG. 5) to determine the first low interference beam. In at least one embodiment, the gNB designs the first low interference beam to maximize its gain at the first gain region and minimize its gain at the first interference avoidance region.

In at least one embodiment, at operation 1040, the gNB determines a second low interference beam (e.g., w^{(j,i)}). In at least one embodiment, to determine the second low interference beam, the gNB determines a second gain region associated with the second user. In some embodiments, the gNB can also determine a second interference avoidance region associated with the first user. In at least one embodiment, the gNB determines the second interference region by determining the first gain region associated with the first user (e.g., as described with reference to FIG. 6, the gain region of the first beam can be set as the interference avoidance region of the second beam). In at least one embodiment, the gNB also considers antenna array information (e.g., antenna array information 525 as described with reference to FIG. 5) and nulling parameters (e.g., nulling parameters 530 as described with reference FIG. 5) to determine the second low interference beam. In at least one embodiment, the gNB designs the second low interference beam to maximize its gain at the second gain region and minimize its gain at the second interference avoidance region.

At operation 1045, the gNB determines if the first low interference beam and the second low interference beam satisfy the threshold condition. For example, the gNB determines if the first low interference beam and the second low interference beam satisfy the SIR threshold value (Γ). In one embodiment, the gNB determines if a SIR^{(a,b)}(w^{(i,j)},w(j,i)>Γ and whether SIR^{(b,a)}(w^{(j,i)},w^{(i,j)})>Γ. In at least one embodiment, the gNB can proceed to operation 1050 if SIR^{(a,b)}(w^{(i,j)},w(ii)>Γ and SIR^{(b,a)}(w(j,i),w^{(i,j)})>Γ. In that, the gNB can proceed to operation 1050 if the resulting designed first low interference beam and second low interference beam now satisfy the threshold condition after utilizing the analog null algorithm. In other embodiments, the gNB can proceed to operation 1055 if SIR^{(a,b)}(w^{(i,j)},w^{(j,i)})<Γ and/or SIR^{(b,a)}(w^{(j,i)},w^{(i,j)})<Γ.

At operation 1050, the gNB performs a MU-MIMO operation with respect to the first user and the second user. That is, the gNB determines designed first low interference beam and designed second interference beam satisfy the threshold criteria. By utilizing the analog null algorithm, additional MU-MIMO opportunities are created—e.g., rather than perform a time division multiple access (TDMA) after determining the first and second beamweights fail the threshold criterion, the gNB utilizes the analog null algorithm and is able to perform a MU-MIMO operation at 1050.

At operation 1055, the gNB performs a TMDA operation. That is, in some embodiments, the gNB utilizes the analog null algorithm to design the first low interference beam and the second low interference beam but still fail to satisfy the threshold criterion. In such examples, the gNB proceeds with a TMDA operation and service the first user and second user sequentially, in some order.

FIG. 11 illustrates an example wireless system implementing an analog beam nulling for MU-MIMO according to embodiments of the present disclosure. In at least one embodiment, FIG. 11 illustrates sectors 1100 (e.g., an example of a cell 500 or coverage area 120 or coverage area 125 as described with reference to FIGS. 1 and 5). In some embodiments, FIG. 11 includes base station (BS) 1105 (e.g., a gNB node 101 as described with reference to FIG. 1). In some embodiments, the BS 1105 is a three sector BS—e.g., the base station 1105 services sector 1100-a, sector 1100-b, and sector 1100-c. For example, the BS 1105 provides wireless access to a network for user equipment (UE) 1110-a and UE 1100-b (e.g., UE 111-UE 116 as described with reference to FIG. 1) located in the sector 1100-a and sector 1100-b, respectively. It should be noted, the hexagonal sectors 1100 are shown as approximately hexagonal for the purposes of illustration and explanation only. In some embodiments, the sectors 1100 may have other shapes, including irregular shapes, depending on the configuration of the BS 1105 servicing the sectors 1100 and other variations in the radio environment associated with natural and man-made obstructions.

In at least one embodiment, the wireless system illustrates a first UE (e.g., UE 1110-a) located in sector 1100-a and a second UE (e.g., UE 1110-b) located in sector 1100-b. In at least one embodiment, sector 1100-a and sector 1100-b are considered co-located (e.g., located adjacently to one another). In at least one embodiment, the BS 1105 services the first UE 1110-a with a first beam (e.g., beam index i as described with reference to FIG. 6) and the second UE 1110-b with a second beam (e.g., beam index j as described with reference to FIG. 6) e.g., service UE 1110-a and UE 1110-b simultaneously. In such embodiments, there can be interference between sector 1110-a and sector 1110-b. That is, servicing UE 1110-a in sector 1100-a can cause an interference for UE 1110-b in sector 1100-b—e.g., interference between the first beam and the second beam. In some embodiments, the interference can be more severe for beams or UE 1110 serviced at or near a sector 1100 boundary.

For example, as illustrated by a sector 1100-a beam pattern, the BS 1105 determines a gain region 1115 for the first beam servicing UE 1110-a. In at least one embodiment, the UE 1110-a is located within the gain region 1115. In some embodiments, the BS 1105 also determines a gain region for the second beam servicing UE 1110-b. As described with reference to FIG. 6, the gain region of the second beam can be set as an interference avoidance region for the first beam. For example, as illustrated by a sector 1110-b beam pattern (e.g., relative to sector 1110-a), the BS 1105 determines an interference region 1120 for the first beam—e.g., set the gain region of the second beam as the interference region 1120 for the first beam. In at least one embodiment, the BS 1105 determines the interference region 1120 coordinates with respect to the local sector—e.g., the BS 1105 expresses the location of the interference region 1120 in sector 1100-a local coordinates. For example, each sector 1100 can span one hundred and twenty degrees (120°). Accordingly, sector 1100-a is represented as spanning from negative sixty degrees (−60°) to positive sixty degrees (60°) while sector 1100-b is represented as spanning from sixty degrees (60°) to one hundred and eighty degrees (180°)—e.g., relative to sector 1100-a, sector 1100-b would span from 60° to 180°.

In some embodiments, the BS 1105 utilizes the analog nulling algorithm (e.g., analog nulling algorithm 535 as described with reference to FIG. 5) after determining the gain region 1115 and the interference region 1120 to maximize the gain for gain region 1115 and minimize the gain for interference region 1120. That is, the BS 1105 designs a first low interference beam (e.g., w^{(i,j)} as described with reference to FIG. 7) taking into account the gain region 1115, interference region 1120, antenna array information, and nulling parameters (e.g., antenna array information 525 and nulling parameters 530 as described with reference to FIG. 5). In some embodiments, the BS 1105 also designs a second low interference beam (e.g., a second low interference beam for the second UE 1110-b, w^{(i,j)}). In such embodiments, the BS 1105 sets the gain region for the second beam as the interference region 1120 and the interference region for the second beam as the gain region 1115 to determine the second low interference beam. Accordingly, the wireless system can use the analog nulling algorithm to reduce interference between co-located cells.

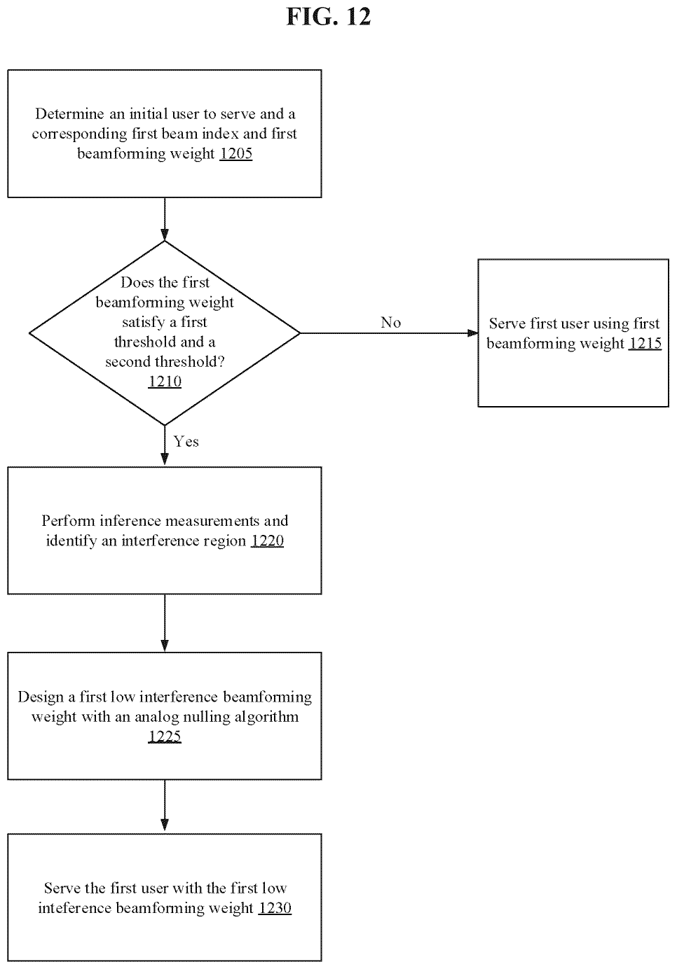

FIG. 12 illustrates a flow chart of an example process of analog beam nulling for inter-cell interference reduction in accordance with an embodiment. Although one or more operations are described or shown in particular sequential order, in other embodiments the operations may be rearranged in a different order, which may include performance of multiple operations in at least partially overlapping time periods.

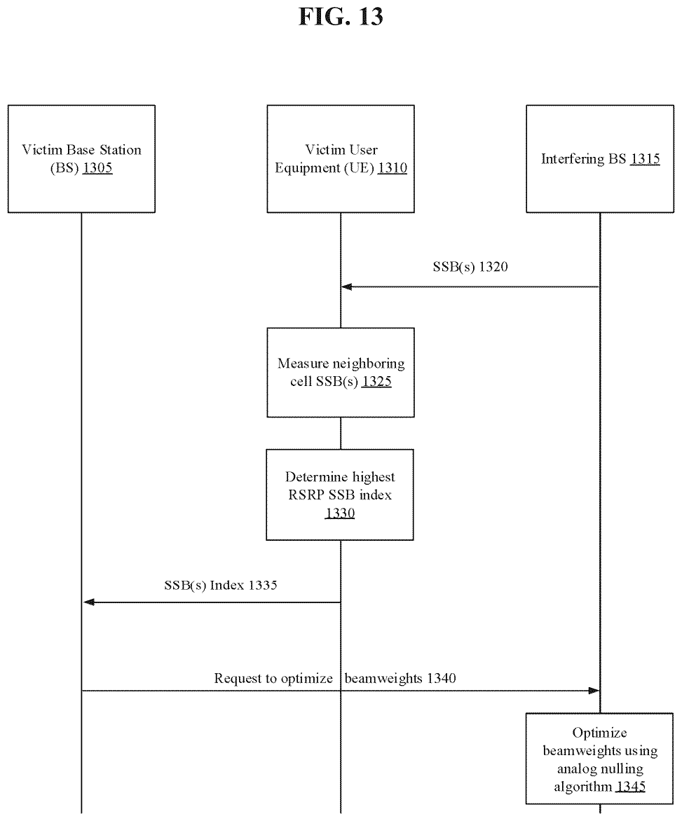

In at least one embodiment, in a wireless system, a first user equipment (e.g., UE 111-116 as described with reference to FIG. 1) could be serviced by a gNB (e.g., gNB 101 as described with reference to FIG. 1). In some embodiments, the first UE (e.g., a victim UE) is in a first sector (e.g., sector 1100 as described with reference to FIG. 11). In some embodiments, a second UE (e.g., an interfering UE) is in a neighboring non-co-located sector interfering with uplink transmission of the first UE in the first sector. In some embodiments, the gNB (e.g., the victim base station (BS)) utilizes the analog nulling parameter described herein to design new beamforming weights to reduce interference. In at least one embodiment, the victim BS coordinates with a second BS (e.g., an interfering BS associated with the second UE) to reduce the interference as described with reference to FIG. 13. In some embodiments, the victim BS reduces interference without coordinating with the second BS as described herein.

At operation 1205, a gNB (e.g., victim BS) determines an initial user to service (e.g., a first user) and a corresponding first beam index and first beamforming weight. In some embodiments, the gNB determines the first beam index utilizing a baseline codebook as described with reference to FIGS. 9 and 10—e.g., determine a beam index i and a first beamforming weight c⁽ⁱ⁾. In some embodiments, the gNB determines the first beam index using digital domain. In other embodiments, the gNB determines the first beam index using analog beam forming as described with reference to FIG. 4.

At operation 1210, the gNB determines whether the first beamweight (e.g., c⁽ⁱ⁾) satisfies a first threshold condition and a second threshold condition. In some embodiments, the gNB determines a signal-to-noise ratio (SNR) and a signal-to-interference ratio (SIR) to determine the interference. For example, the gNB compares the determined SNR value with a threshold SNR value (Γ^{SNR}) and the determined SIR value with a threshold SIR value (Γ^{SIR}) as expressed by equations (5) and (6):

$${SIR}^{( a )} ( {c}^{( i )} ) < {Γ}^{SIR} \qquad ( 5 )$$

$${SNR}^{( a )} ( {c}^{( i )} ) > {Γ}^{SNR} \qquad ( 6 )$$

where SIR^{(a)} represents the determined SIR value for the first beam servicing the first user (e.g., user a) and SNR^{(a)} represents the determined SNR value for the first beam servicing the first user. In at least one embodiment, the gNB determines there is an interferer if SNR is above the threshold SNR value (Γ^{SNR}) and the SIR value is below the threshold SIR value (Γ^{SIR}). In such embodiments, the gNB proceeds to operation 1220 (e.g., the gNB can determine the first and second thresholds are satisfied and proceed to operation 1220). In other embodiments, the gNB determines there is no strong interferer if the SIR value is above the threshold SIR value (Γ^{SIR}). In such embodiments, the gNB proceeds to operation 1215. That is, the gNB can determine there is likely interference when the SNR is above the threshold SNR and the SIR is below the threshold SNR, the gNB can determine there is likely not strong interference when the SNR is above the threshold SNR and the SIR is above the threshold SIR, the gNB can determine there is no interference when the SNR is below a threshold SNR and a SIR is above the threshold SIR, and the gNB can fail to determine if there is an interference when SNR is below a threshold SNR and SIR is below a threshold SIR.

At operation 1215, the gNB services the first user using the first beamforming weight. That is, when the gNB determines there is no interferer, the gNB can proceed with using the initially obtained beamforming weight determined by the baseline codebook.

At operation 1220, the gNB performs one or more inference measurements and identify an interference region. For example, after determining there is an interferer at operation 1210, the gNB initiates interference measurements by sweeping its receiver beams in multiple directions. In at least one embodiment, the gNB determines a worst interference region after performing the interference measurements—e.g., the gNB determines which direction a receiver beam recorded the highest interference power.

At operation 1225, the gNB designs a first low interference beamweight using an analog nulling algorithm (e.g., analog nulling algorithm 535 as described with reference to FIG. 5). For example, the gNB determines which receiver beam utilized was the cause of the worst interference. In one embodiment, the gNB determines a second beam (e.g., beam j) was used when the worst interference is measured. In such embodiments, the gNB optimizes the beamforming weights of the first beam (e.g., beam i) such that the highest gain for beam i is its gain region (e.g., Gᵢ) and its lowest gain is its interference region—e.g., which is the gain region for the second beam, Lᵢ=Gⱼ, where Lᵢ is the interference region for beam i and Gⱼ is the gain region for beam j.

At operation 1230, the gNB services the first user using the first low interference beamforming weight (e.g., w^{(i,j)}). By utilizing the analog nulling algorithm, the gNB services the first user even with an interfering UE in a neighboring sector.

FIG. 13 illustrates a flow chart of an example process of analog beam nulling for MU-MIMO in accordance with an embodiment. Although one or more operations are described or shown in particular sequential order, in other embodiments the operations may be rearranged in a different order, which may include performance of multiple operations in at least partially overlapping time periods. As described with reference to FIG. 12, a wireless system can include a first user (e.g., a victim user equipment (UE)) in a first sector and a second interfering user (e.g., an interfering UE) in a second neighbor sector. For example, the first user and second user could interfere with each other in downlink (DL) transmission. In some examples, the interference is higher for users close to boundaries between to sectors served simultaneously. In at least one embodiment, a victim base station (BS) (e.g., a BS servicing the first user) coordinates with a second BS (e.g., an interfering BS associated with the interfering UE) to reduce the interference with an analog nulling algorithm as described herein. Accordingly, the flow chart processes can be performed by a victim base station 1305, a victim UE 1310, and an interfering BS 1315, where the interfering BS 1315 is associated with the second UE in a neighbor sector. In some embodiments, the victim BS 1305 and interfering BS 1315 can be examples of one of gNB 101, 102, 103 as described with reference to FIG. 1. In at least one embodiment, the UE 1310 can be an example of a UE 111-116 as described with reference to FIG. 1.

At operation 1320 and 1325, the victim UE 1310 measures synchronization signal block (SSB) transmission from an interfering sector. That is, the interfering BS 1315 can transmit periodic SSB transmissions 1320. In some embodiments, the victim UE 1310 measures the SSB transmissions from the interfering BS 1315 (e.g., from the interfering sector). For example, the victim UE 1310 measures PBCH-DMRS signals (e.g., physical broadcast channel-demodulated reference signals).

At operation 1330, the victim UE 1310 determines a highest reference signal received power (RSRP) SSB index based on measuring the SSB transmission from the interfering BS 1315. That is, the victim UE 1310 determines the highest received power specifically related to the SSB block within the UE 1310 sector.

At operation 1335, the victim UE 1310 transmits (e.g., report) the SSB(s) index of the interfering BS 1315. In some embodiments, the victim BS 1305 receives the SSB report from the UE and determines an interference region associated with the victim UE 1310—e.g., the victim BS 1305 can set an interference region as a gain area of the reported SSB beams.

At operation 1340, the victim BS 1305 transmit a request to the interfering BS 1315 to optimize the interfering BS 1315 beam weights to have a low interference with the victim UE 1310. For example, the victim BS 1305 indicates an interference area the interfering BS 1315 should minimize its gain in.

At operation 1345, the interfering BS 1315 optimizes its beamforming weights using an analog nulling algorithm (e.g., analog nulling algorithm 535). In some embodiments, the interfering BS 1315 designs its beamforming weights by taking into account antenna array information, nulling parameters, the gain region for the interfering UE associated with the interfering BS, and the interference area determined by the victim BS 1305 (e.g., antenna array information 525 and nulling parameters 530 as described with reference to FIG. 5). Accordingly, by using the analog nulling algorithm in coordination with the victim BS 1305, the interfering BS 1315 reduces the interference of its beams with the victim UE 1310 providing a better overall user experience.

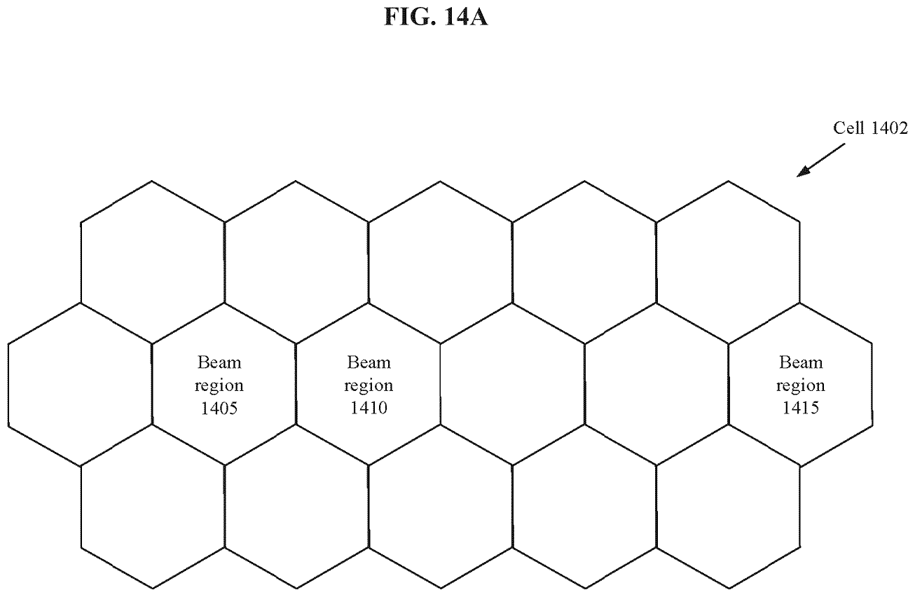

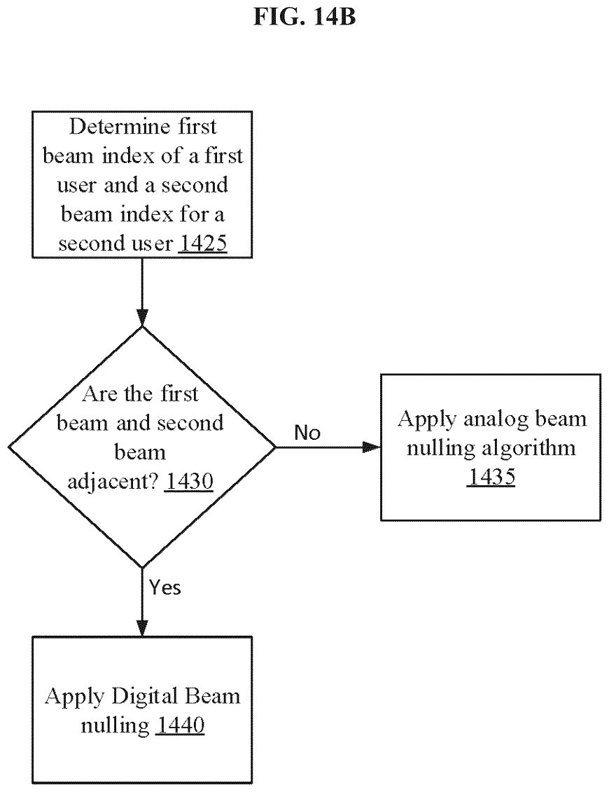

FIG. 14A illustrates a cell 1402 in an example wireless system implementing an analog beam nulling for multi-user multiple-input multiple-output (MU-MIMO) according to embodiments of the present disclosure. In at least one embodiment, FIG. 14A illustrates a cell 1402 (e.g., a cell sector or coverage area 120 or coverage area 125 as described with reference to FIG. 1). In some embodiments, a gNodeB (e.g., gNB 101, gNB 102, or gNB 103 as described with reference to FIG. 1) can provide wireless access to a network to user equipment (e.g., UE 111-UE 116 as described with reference to FIG. 1) located in the cell 1402. In at least one embodiment, the cell 1402 includes beam regions (e.g., beam region 1405, beam region 1410, and beam region 1415). In at least one embodiment, each beam region corresponds to a gain region for a respective beam. For example, beam region 1405 corresponds to a gain region for a first beam (e.g., beam i), beam region 1410 corresponds to a gain region for a second beam (e.g., beam j), and beam region 1415 corresponds to a gain region for a third beam (e.g., beam k). It should be noted, the beam region 1405, beam region 1410, and beam region 1415 are shown as approximately hexagonal for the purposes of illustration and explanation only. In some embodiments, the 1402 may have other shapes, including irregular shapes, depending on the configuration of the gNB servicing the cell 1402 and other variations in the radio environment associated with natural and man-made obstructions.

In some embodiments (e.g., as described with reference to FIGS. 14-16), the wireless system implements analog nulling and digital nulling as complementary methods. In at least one embodiment, analog beam nulling is difficult or challenging when serving adjacent users. For example, beam region 1405 corresponds to a first user, beam region 1410 corresponds to a second user, and beam 1415 corresponds to a third user. In some embodiments, because beam region 1405 and beam region 1410 are adjacent (e.g., the first user is adjacent to the second user), the gNB can have difficult designing the analog nulling beams as the intended gain region and interference avoidance region are adjacent for a respective beam—e.g., a first beam associated with beam region 1405 has a gain region corresponding to beam region 1405 but an adjacent interference region corresponding to beam region 1410. In such embodiments, the gNB switches to a digital nulling method and cancel interference between beam region 1405 and beam region 1410 in the digital domain. In at least one embodiment, the gNB performs digital nulling methods by performing channel estimates—e.g., measure sound reference signals (SRS) in uplink transmissions, using a precoded matrix indicator (PMI) feedback from a user equipment (UE) based on channel state information reference signals (CSI-RS), demodulated reference signals (DMRS) in the physical uplink shared channel (PUSCH channel), or any other digital nulling technique. In some embodiments, the digital nulling is implemented through zero-forcing precoding/combining or regularized zero-forcing precoding/combining. In embodiments where the gNB utilizes both analog and digital nulling, the gNB turns on the digital nulling only when necessary to reduce overhead and increase overall performance of the system.

FIG. 14B illustrates a flow chart of an example process of analog beam nulling for MU-MIMO in accordance with an embodiment. Although one or more operations are described or shown in particular sequential order, in other embodiments the operations may be rearranged in a different order, which may include performance of multiple operations in at least partially overlapping time periods. In at least one embodiment, FIG. 14B illustrates one possible solution of using analog nulling and digital nulling as complementary methods. In some embodiments, digital beam nulling could be applied to all users when any two beams are adjacent. In other embodiments, a gNB (e.g., gNB 101 as described with reference to FIG. 1) can utilize digital beam nulling for adjacent beams and use analog nulling of non-adjacent beams as described herein.

At operation 1425, a gNB determines a first beam index of a first user and a second beam index of a second user. For example, the gNB determines a first user to service and a second user to service. In some embodiments, the gNB determines the first beam index and the second beam index using a baseline codebook, accessing a stored value, or any other method described herein. For example, the gNB determines the first beam index i for the first user and the second beam index j for the second user.

At operation 1430, the gNB determines if the beams are adjacent. In some embodiments, the gNB proceeds to operation 1435 if the first beam and the second beam are not adjacent—e.g., the gNB can perform an analog null operation. In other embodiments, the gNB proceeds to operation 1440 if the first beam and the second beam are adjacent. For example, the gNB determines a first beam corresponds to beam region 1405, a second beam corresponds to beam region 1410, and a third beam corresponds to beam region 1415. In such embodiments, the gNB determines whether to perform an analog nulling operation based on which pair of beams is selected. For example, the gNB can determine that the first beam and the third beam are non-adjacent as well as that the second beam and third beam are non-adjacent. In such embodiments, the gNB proceeds to operation 1435 for the first beam and third beam pair and the second beam and third beam pair. In other examples, the gNB determines the first beam and the second beam are adjacent (e.g., beam region 1405 is adjacent to beam region 1410). In such examples, the gNB can proceed to operation 1440 (e.g., proceed to use digital nulling) for the first beam and second beam pair.

At operation 1435, the gNB applies an analog beam nulling algorithm to determine low interference beamforming weights as described with reference to FIGS. 5-6. For example, the gNB applies a beam nulling algorithm to design the first beam and third beam pair. In such embodiments, the gNB maximizes the gain of the first beam at beam region 1405 (e.g., the gain region associated with the first beam and first user) and minimizes the gain of the first beam at the beam region 1415 (e.g., the gain region associated with the third beam and the interference avoidance region associated with the first beam). Additionally, the gNB maximizes the gain of the third beam at the beam region 1415 and minimizes the gain at beam region 1405 (e.g., the interference avoidance region associated with the third beam). In some examples, the gNB also applies a beam nulling algorithm to design the second beam and third beam pair. For example, the gNB maximizes the gain of the second beam at beam region 1410 (e.g., the gain region associated with the second beam and second user) and minimizes the gain of the second beam at the beam region 1415 (e.g., the gain region associated with the third beam and the interference avoidance region associated with the second beam). Additionally, the gNB maximizes the gain of the third beam at the beam region 1415 and minimizes the gain at beam region 1410 (e.g., the interference avoidance region associated with the third beam). By utilizing the nulling algorithm, the interference associated with the first beam and third beam pair as well as the second beam and third beam pair is reduced.

At operation 1440, the gNB estimates digital domain equivalent channel and applies digital beam nulling on non-adjacent beam pairs. For example, the gNB determines the first beam is adjacent to the second beam—e.g., beam region 1405 is adjacent to bean region 1410. In such embodiments, the gNB can use digital beam nulling to the first beam and second beam pair. As described with reference to FIG. 14, the digital beam nulling includes performing channel estimates—e.g., measure sound reference signals (SRS) in uplink transmissions, using a precoded matrix indicator (PMI) feedback from a user equipment (UE) based on channel state information reference signals (CSI-RS), demodulated reference signals (DMRS) in the physical uplink shared channel (PUSCH channel), or any other digital nulling technique. By implementing both digital and analog nulling methods, the overall interference of the system is reduced.

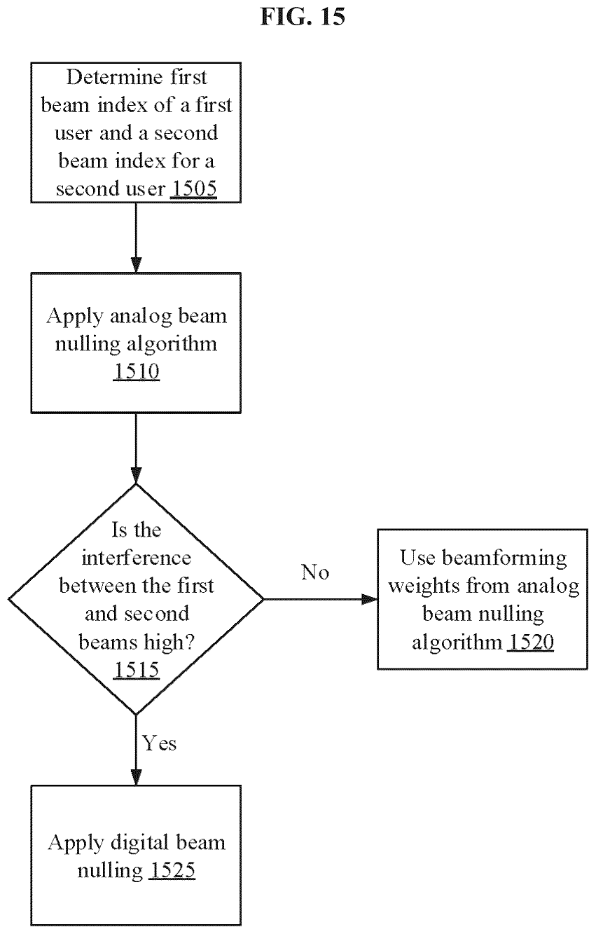

FIG. 15 illustrates a flow chart of an example process of analog beam nulling for MU-MIMO in accordance with an embodiment. Although one or more operations are described or shown in particular sequential order, in other embodiments the operations may be rearranged in a different order, which may include performance of multiple operations in at least partially overlapping time periods. In at least one embodiment, FIG. 15 illustrates one possible solution of using analog nulling and digital nulling as complementary methods. In one embodiment, a gNB (e.g., gNB 101 as described with reference to FIG. 1) can utilize digital beam nulling after and utilizing analog beam if there is still high interference as described herein.

At operation 1505, a gNB determines a first beam index of a first user and a second beam index of a second user. For example, the gNB determines a first user to service and a second user to service. In some embodiments, the gNB determines the first beam index and the second beam index using a baseline codebook, accessing a stored value, or any other method described herein. For example, the gNB determines the first beam index i for the first user and the second beam index j for the second user.

At operation 1510, the gNB applies an analog beam nulling algorithm (e.g., analog nulling algorithm 535 as described with reference to FIG. 5) to determine a first low interference beamforming weight and a second low interference beamforming weight. For example, the gNB applies a beam nulling algorithm to design the first beam and second beam pair. In such embodiments, the gNB maximizes a gain of the first beam a gain region associated with the first beam and first user and minimizes a gain of the first beam at the gain region associated with the second beam—e.g., set the gain region of the second beam as the interference avoidance region associated with the first beam. Additionally, the gNB maximizes a gain of the second beam at the gain region associated with the second beam and minimizes a gain at the interference avoidance region associated with the second beam—e.g., set the gain region of the first beam as the interference avoidance region of the second beam.

At operation 1515, the gNB determines if a residual interference (e.g., the interference of between the newly designed first low interference beam and the second low interference beam) satisfies a threshold condition. In some embodiments, the gNB measures an uplink SINR associated with the first user using the first interference beam and an uplink SINR associated with the second user using the second interference beam. In some embodiment, the gNB determines the remaining interference is high (e.g., the threshold criteria is not satisfied) if the calculated SINR falls below a threshold value as expressed by equation (7):

$${SINR}^{( a )} < {Γ}^{SINR} \qquad ( 7 )$$

where SINR^{(a)} represents the calculated SINR value for the first user and Γ^{SINR} is a threshold SINR value. In at least one embodiment, if the gNB determines the residual interference is below a threshold value, the gNB can proceed to operation 1520. In other embodiments, the gNB determines the residual interference is above a threshold value and proceeds to operation 1525. That is, after performing the analog nulling operation, the gNB can proceed with utilizing the designed low interference beamforming weights if the remaining interference is low or the gNB can proceed with digital nulling if the remaining interference is high. For example, the gNB can use the analog nulling algorithm but a subset of UEs associated with the analog nulling algorithm may observe low SINR as a result. In such embodiments, the gNB can proceed to operation 1525 to boost the SINR of each UE and attempt a MU-MIMO operation.

At operation 1520, the gNB uses beamforming weights determined from the analog beam nulling algorithm. For example, the gNB services a first user using the first low interference beamforming weight.

At operation 1525, the gNB applies digital beam nulling to the determined low interference beamforming weights. For example, the gNB estimates a digital domain equivalent channel and apply digital beam nulling. As described with reference to FIG. 14B, the digital beam nulling can include performing channel estimates—e.g., measure sound reference signals (SRS) in uplink transmissions, using a precoded matrix indicator (PMI) feedback from a user equipment (UE) based on channel state information reference signals (CSI-RS), demodulated reference signals (DMRS) in the physical uplink shared channel (PUSCH channel), or any other digital nulling technique. In some embodiments, the gNB can perform digital nulling by estimating downlink SINR through channel quality information (CQI) or reference signal received quality (RSRQ) feedback provided by the first UE. By implementing digital nulling methods after analog nulling methods, the overall interference of the system is reduced.

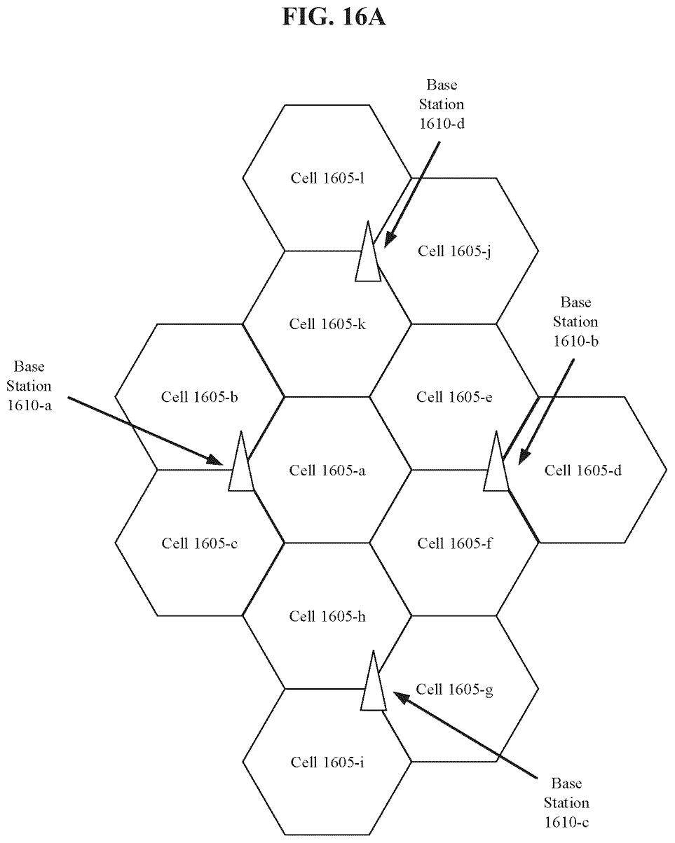

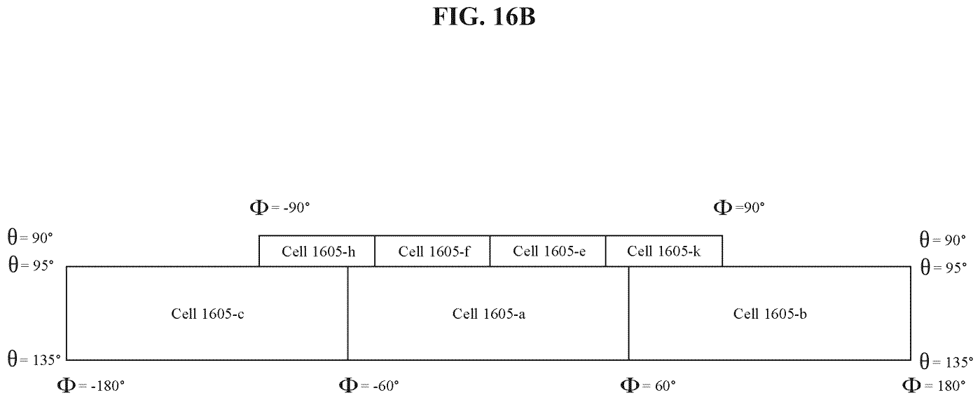

FIGS. 16A and 16B illustrate an example wireless system implementing an analog beam nulling for MU-MIMO according to embodiments of the present disclosure. In at least one embodiment, FIG. 16 illustrates cells 1600 (e.g., an example of a cell 500, coverage area 120 or coverage area 125, and/or an example of sector 1100 as described with reference to FIGS. 1,5, and 11). In some embodiments, FIG. 16 includes base stations (BS) 1610 (e.g., a gNB node 101 as described with reference to FIG. 1). In some embodiments, each BS 1610 is a three sector BS—e.g., the base station 1610-a services cell 1605-a, cell 160 FIG. 11 illustrates an example wireless system implementing an analog beam nulling for MU-MIMO according to embodiments of the present disclosure. In at least one embodiment, FIG. 11 illustrates sectors 1100 (e.g., an example of a cell 500 or coverage area 120 or coverage area 125 as described with reference to FIGS. 1 and 5). In some embodiments, FIG. 11 includes base station (BS) 1105 (e.g., a gNB node 101 as described with reference to FIG. 1). In some embodiments, the BS 1105 is a three sector BS—e.g., the base station 1105 services sector 1100-a, sector 1100-b, and cell 1605-c. In some embodiments, each cell 1600 may include one or more user equipment (UE) (e.g., UE 111-UE 116 as described with reference to FIG. 1). In such embodiments, the base station 1610 may service one or more UEs simultaneously in a MU-MIMO operation. It should be noted, the hexagonal cells 1600 are shown as approximately hexagonal for the purposes of illustration and explanation only. In some embodiments, the cells 1600 may have other shapes, including irregular shapes, depending on the configuration of the BS 1605 servicing the sectors 1600 and other variations in the radio environment associated with natural and man-made obstructions.

In at least one embodiment, FIG. 16 illustrates one possible configuration of base stations 1610 and cells 1605. In one embodiment, each base station 1610 services three (3) cells 1605. In such examples, four BS 1610 can service the entire twelve cell 1605 arrangement. In some embodiments, each BS 1610 can be associated with one or more co-located cells 1605 and one or more non-co-located cells 1605. For example, the base station 1610-a services the cell 1605-a, cell 1605-b, and cell 1605-c. In one embodiment, while the base station is servicing a UE in cell 1605-a, cell 1605-b and cell 1605-c are co-located with respect to cell 1605-a while cell 1605-e is non-co-located.

In at least some embodiments, the BS 1610 is configured to use a beam nulling algorithm as described with reference to FIG. 5. In at least one embodiment, the BS 1610 can use an analog beam nulling algorithm for inter-cell interference and a digital beam nulling algorithm for intra-cell interference. For example, the BS 1610-a can use an analog beam nulling algorithm to design low interference analog beams at cell 1605-a with respect to one or more other cells 1605—e.g., the BS 1610 can design a low interference beam that maximizes its gain at cell 1605-a and minimizes it gain at other cells 1605. In such embodiments, the BS 1610-a can use a digital beam nulling algorithm when servicing two users in cell 1605-a (e.g., for the intra-cell interference).

In at least one embodiment, FIG. 16B illustrates an angular domain of the one or more cells 1605. In one example, FIG. 16B is represented as cell 1605-a local coordinates—e.g., the coordinates of cells 1605-b through 1605-k are represented as local cell 1605-a coordinates. For example, cell 1605-a covers a horizontal region spanning from −60° to 60°, cell 1605-b covers a horizontal region spanning from 60° to 180°, and cell 1605-c covers a horizontal region spanning from −60° to −180°. In such embodiments, the cell 1605-a further covers a vertical region spanning from 95° to 135° and cell 1605-h, cell 1605-f, cell 1605-e, and cell 1605-k cover a vertical region spanning from 90° to 95°. In at least one embodiment, FIG. 16B illustrates cell 1605-b and cell 1605-c as co-located with cell 1605-a and cell 1605-h, cell 1605-f, cell 1605-c, and cell 1605-k are non-co-located with cell 1605-a. In at least one embodiment, the BS 1610 can design analog beams using the analog beam nulling method to maximize the gain of cell 1605-a analog beams at the horizontal region −60° to 60° and vertical region 95° to 135° and minimize the gain of cell 1605-a analog beams outside of that region. In at least one embodiment, by using analog and digital beam nulling, the BS 1610-a could improve the overall performance of the system.

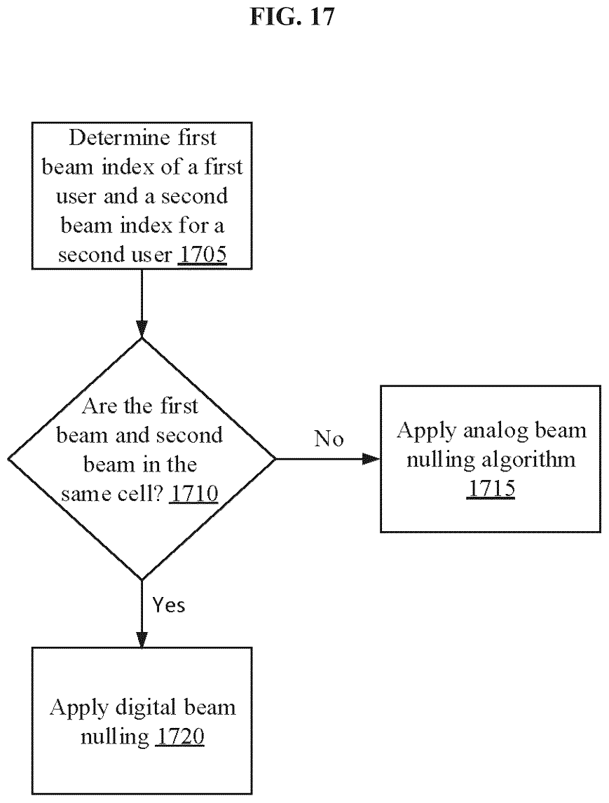

FIG. 17 illustrates a flow chart of an example process of analog beam nulling for MU-MIMO in accordance with an embodiment. Although one or more operations are described or shown in particular sequential order, in other embodiments the operations may be rearranged in a different order, which may include performance of multiple operations in at least partially overlapping time periods. In at least one embodiment, FIG. 17 illustrates one possible solution of using analog nulling and digital nulling as complementary methods. In some embodiments, digital beam nulling could be applied for intra-cell interference—e.g., for two users in a same cell or sector as described with reference to FIGS. 6-10). In some embodiments, analog digital nulling could be applied for inter-cell interference cancelation (e.g., for two users in a different cell, whether co-located or non-co-located as described with reference to FIGS. 11-16) as described herein. In at least one embodiment, one or more operations described herein are described with respect to the wireless system described with reference to FIG. 16A.

At operation 1705, a gNB (e.g., gNB 101 as described with reference to FIG. 1) determines a first beam index of a first user and a second beam index of a second user. For example, the gNB determines a first user to service and a second user to service. In some embodiments, the gNB determines the first beam index and the second beam index using a baseline codebook, accessing a stored value, or any other method described herein. For example, the gNB determines the first beam index i for the first user and the second beam index j for the second user.

At operation 1710, the gNB determines if the first beam and the second beam are in the same cell (e.g., cell 1600 as described with reference to FIG. 16A). In at least one embodiment, the gNB determines the first beam and the second beam are in a same cell. In such embodiments, the gNB can proceed to operation 1720 and perform digital beam nulling. In other embodiments, the gNB determines the first beam and the second beam are in a different cell. For example, the gNB determines the first beam is associated with a first cell and the second beam is associated with a second cell—e.g., cell 1605-a and cell 1605-b, respectively, as described with reference to FIG. 16. In such embodiments, the gNB can proceed to operation 1715 and apply an analog beam nulling algorithm (e.g., analog nulling algorithm 535 as described with reference to FIG. 5).

At operation 1715, the gNB applies an analog beam nulling algorithm to determine a low interference beamforming weight. In at least one embodiment, the gNB uses analog beam nulling for inter-cell interference, particularly when the first beam is close to a boundary or edge of the respective cell/sector. For example, the gNB determines a first user is located on an edge between cell 1605-a and cell 1605-b as described with reference to FIG. 16A. In one example, the first user is at an angle fifty-seven degrees (57°) while a second user is at an angle sixty-five (65°)—e.g., the first user is in cell 1605-a while the second user is in cell 1605-b. In such embodiments, the gNB uses an analog beam nulling algorithm to reduce interference at the second cell (e.g., reduce an interference in a sidelobe region of sixty to hundred eighty degrees (60°-180°). For example, the gNB maximizes a gain for the first beam at 57° (e.g., a gain region for the first beam) and minimizes a gain for the first beam at 65° (e.g., the gain region for second beam is set as the interference region for the first beam). In at least one embodiment, during scheduling the gNB determines to service users far away in an angular domain to reduce intra-cell interference (e.g., the gNB can serve two non-co-located sectors). In at least one embodiment, the gNB does not change information or transmission coordinates among cells to apply the analog beam nulling algorithm. In at least one embodiment, the gNB services non-co-located cells and apply the analog beam nulling algorithm by considering both horizontal and vertical domains as described with reference to FIG. 16B. For example, the gNB determines there are one or more neighboring sectors in the horizontal direction (e.g., co-located cell 1605-b and cell 1605-c) and determines there are one or more neighboring sectors in the vertical direction (e.g., non-co-located cell 1605-h, cell 1605-f, cell 1605-c, and cell 1605-k). In such embodiments, the gNB designs an analog beam that maximizes its gain in its respective region (e.g., maximize the first beam in cell 1605-a) and minimize its gain in the neighboring sectors in the horizontal and vertical direction (e.g., the gNB can minimize the gain of the first beam in both cell 1605-b and cell 1605-c).

At operation 1720, the gNB applies digital beam nulling to reduce intra-cell interference. For example, the gNB estimates a digital domain equivalent channel and apply digital beam nulling. As described with reference to FIG. 14B, the digital beam nulling includes performing channel estimates—e.g., measure sound reference signals (SRS) in uplink transmissions, using a precoded matrix indicator (PMI) feedback from a user equipment (UE) based on channel state information reference signals (CSI-RS), demodulated reference signals (DMRS) in the physical uplink shared channel (PUSCH channel), or any other digital nulling technique. In some embodiments, the gNB performs digital nulling by estimating downlink SINR through channel quality information (CQI) or reference signal received quality (RSRQ) feedback provided by the first UE. By implementing digital nulling methods for intra-cell interference and analog nulling methods for inter-cell interference, the overall interference of the system is reduced.

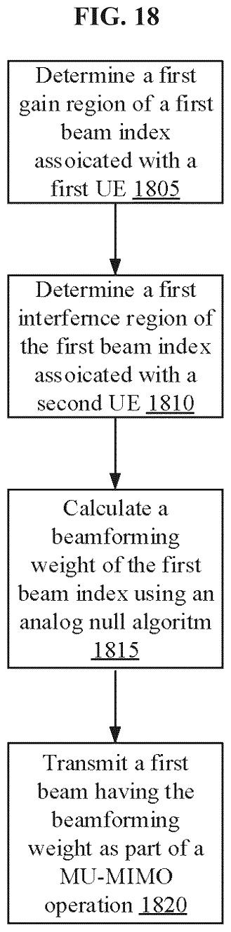

FIG. 18 illustrates a flow chart of an example process of analog beam nulling for MU-MIMO in accordance with an embodiment. Although one or more operations are described or shown in particular sequential order, in other embodiments the operations may be rearranged in a different order, which may include performance of multiple operations in at least partially overlapping time periods. In at least one embodiment, the operations and processes described herein are performed by a base station (BS) or gNB (e.g., base station or gNB 101, 102, or 103 as described with reference to FIG. 1).

At operation 1805, a base station (e.g., a processor coupled to memory of the base station) determines a first gain region of a first beam index associated with a first UE—e.g., a UE 111-116 as described with reference to FIG. 1. In at least one embodiment, the first UE is in a first cell or sector (e.g., cell 500 or sector 1100 as described with reference to FIGS. 5 and 11). In some embodiments, the BS can determine an initial beamforming weight of the first beam index. For example, the BS can determine the initial beamforming weight using a beam tracking algorithm or a beam management module as described with reference to FIG. 9. In some embodiments, the BS can determine the initial beamforming weights using both a beam tracking algorithm and a beam management module as described with reference to FIG. 9. In some embodiments, the BS can determine the initial beamforming weight using a baseline codebook as described with reference to FIG. 9. In at least some embodiments, the BS can determine the gain region of the first beam index based on determining the initial beamforming weight (e.g., by determining an initial beam index i). In some embodiments, the BS can compare the initial beamforming weight to a second threshold criterion. For example, the BS can determine a signal-to-interference ratio (SIR) for the initial beamforming weight and compare the determined SIR with a threshold SIR value—e.g., a threshold SIR value for performing a MU-MIMO operation. In some embodiments, the BS can determine the initial beamforming weights fail to satisfy the second threshold criterion and determine the beamforming weight of the first beam index based at least in part on determining the initial beamforming weight fails to satisfy the second threshold criterion. That is, in some embodiments, the BS can get an initial beamforming weight and determine it cannot perform a MU-MIMO operation with the initial beamforming weight. In such embodiments, the BS can use the analog beam nulling to design new low interference beams and increase MU-MIMO operations as described with reference to FIG. 10.

At operation 1810, the BS determines a first interference region of the first beam index associated with serving a second UE. In at least one embodiment, the BS can determine a second gain region of the second beam index associated with serving a second UE. In such embodiments, the BS can set the second gain region as the first interference region of the first beam index as described with reference to FIGS. 6A and 6B. In some embodiments, the BS can determine a second interference region of the second beam index associated with serving the first UE, where the second interference region is equivalent to the first gain region—e.g., Lⱼ=Gᵢ.

At operation 1815, the BS calculates a beamforming weight of the first beam index using an analog nulling algorithm, where the first gain region and the first interference region are inputs the analog null algorithm to optimize for a threshold criterion. In some embodiments, the BS can also input nulling parameters and respective antenna array information (e.g., nulling parameters 530 and antenna array information 525 as described with reference to FIG. 5). In at least one embodiment, the analog null algorithm optimizes for a signal-to-leakage ratio (SLR). In at least one embodiment, the BS can also calculate a second beamforming weight of the second beam index using the analog null algorithm where the second gain region and the second interference region are the inputs to the analog null algorithm to optimize for the SLR. In some examples, the BS can determine a second gain region from a plurality of gain regions corresponding to a second beam index of a plurality of beam indices associated with serving a plurality of UE. In such examples, the BS can determine a plurality of interference regions corresponding to the plurality of beam indices based at least in part on determining the second region. In some examples, the BS can calculate a second beamforming weight of a plurality of beamforming weights for the plurality of beam indices using the analog null algorithm, where the second beamforming weight has a maximum gain at the second gain region and a minimum gain at the plurality of interference regions corresponding to the plurality of beam indices—e.g., a beam maximizes its gain in its gain region and minimizes its gain in the gain region of all other beam indices.

At operation 1820, the BS can transmit a first beam having the beamforming weight of the first beam index as part of a MU-MIMO operation. In at least one embodiment, the BS can also transmit a second beam having the second beamforming weight of the second beam index as part of the MU-MIMO operation—e.g., the BS can transmit the first and second beam simultaneously. In some examples, the BS can also include an antenna array configured to transmit one or more beams. In such examples, the BS can adjust a phase shifter value to achieve the first beamforming weight to transmit the first beam having the beamforming weight. In some examples, the first UE and the second UE are located in a first cell. That is, the BS can use the analog nulling algorithm for intra-cell interference as described with reference to FIGS. 6-10. In other examples, the first UE is located in a first cell and the second UE is located in as second. In one example, the first cell is co-located to the second cell. In other examples, the first cell is non-co-located to the second cell. In some embodiments, the UE can communicate with a second BS to determine SSB indexes and have the BS transmit analog beam nulling algorithm information to the second BS as described with reference to FIG. 13. In other embodiments, the BS can perform analog beam nulling for inter-cell cancellation, intra-cell cancellation, cancellation between two co-located cells, and cancellation between two-non-co-located cells. In some embodiments, the BS can use the analog beam nulling algorithm before, after, or while using a digital beam nulling algorithm. For example, the BS can obtain initial beamforming weights by using the digital beam nulling algorithm, the BS can use digital beam nulling after applying analog digital nulling, or use analog beam nulling for inter-cell cancellations and digital beam nulling for intra-cell cancellations. In some embodiments, the BS can store the beamforming weight of the first beam index—e.g., the BS can store frequently used beamforming weights. In other embodiments, the BS can perform each analog beam nulling calculation online.

In at least one embodiment, utilizing the analog beam null algorithm increase the overall throughput of the system. For example, the analog beam nulling algorithm designs beamforming weights with high gain in desired regions and low leakage in other regions, which improves the signal-to-interference ratio (SIR) of each user and maximizes the overall signal-to-leakage-ratio (SLR). In at least one embodiment, the analog beam nulling algorithm can also increase the MU-MIMO opportunities, causing the overall system throughput to increase. Utilizing the analog beam nulling algorithm leads to a high spectral efficiency (SE) of the wireless system.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the inventive subject matter. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A base station (BS) in a wireless network, comprising:
a memory; and
a processor coupled to the memory, the processor configured to:
determine a first gain region of a first beam index associated with serving a first user equipment (UE);
determine a first interference region of the first beam index associated with serving a second UE;
calculate a beamforming weight of the first beam index using an analog null algorithm wherein the first gain region and the first interference region are inputs to the analog null algorithm to optimize for a threshold criterion; and
transmit a first beam having the beamforming weight of the first beam index as part of a multi-user multiple-input multiple-output (MU-MIMO) operation.

2. The BS of claim 1, wherein to determine the first interference region of the first beam, the processor is configured further to:
determine a second gain region of a second beam index associated with serving the second UE;
determine a second interference region of the second beam index associated with serving the first UE, wherein the second interference region is equivalent to the first gain region; and
calculate a second beamforming weight of the second beam index using the analog null algorithm wherein the second gain region and the second interference region are inputs to the analog null algorithm to optimize for a signal-to-leakage ratio (SLR).

3. The BS of claim 1, wherein the processer is configured further to:
determine a second gain region from a plurality of gain regions corresponding to a second beam index of a plurality of beam indices associated with serving a respective plurality of UE;
determine a plurality of interference regions corresponding to the plurality of beam indices based at least in part on determining the second gain region; and
calculate a second beamforming weight of a plurality of beamforming weights for the plurality of beam indices using the analog null algorithm, wherein the second beamforming weight has a maximum gain at the second gain region and a minimum gain at the plurality of interference regions corresponding to the plurality of beam indices.

4. The BS of claim 1, further comprising:
an antenna array configured to transmit one or more beams, and wherein to transmit the first beam having the first beamforming weight, the processor is further configured to:
adjust a phase shifter value to achieve the first beamforming weight.

5. The BS of claim 1, wherein:
the first UE and the second UE are located in a first cell.

6. The BS of claim 1, wherein:
the first UE is located in a first cell; and
the second UE is located in a second cell, wherein the first cell is co-located to the second cell.

7. The BS of claim 1, wherein:
the first UE is located in a first cell; and
the second UE is located in a second cell, wherein the first cell is non-co-located to the second cell.

8. The BS of claim 1, wherein the processor is further configured to:
determine an initial beamforming weight using a beam tracking algorithm or a beam management module, wherein determining the gain region of the first beam index is based at least in part on determining the initial beamforming weight.

9. The BS of claim 8, wherein the processor is further configured to:
compare the initial beamforming weight to a second threshold criterion; and
determine the initial beamforming weight fails to satisfy the second threshold criterion, wherein calculating the beamforming weight of the first beam index is based at least in part on determining the initial beamforming weight fails to satisfy the second threshold criterion.

10. The BS of claim 1, wherein the processor is further configured to:
store the beamforming weight of the first beam index.

11. A method performed by a base station (BS) in a wireless network, comprising:
determining a first gain region of a first beam index associated with serving a first user equipment (UE);
determining a first interference region of the first beam index associated with serving a second UE;
calculating a beamforming weight of the first beam index using an analog null algorithm wherein the first gain region and the first interference region are inputs to the analog null algorithm to optimize for a threshold criterion; and
transmitting a first beam having the beamforming weight of the first beam index as part of a multi-user multiple-input multiple-output (MU-MIMO) operation.

12. The method of claim 11, wherein determining the first interference region of the first beam further comprises:
determining a second gain region of a second beam index associated with serving the second UE;
determining a second interference region of the second beam index associated with serving the first UE, wherein the second interference region is equivalent to the first gain region; and
calculating a second beamforming weight of the second beam index using the analog null algorithm wherein the second gain region and the second interference region are inputs to the analog null algorithm to optimize for a signal-to-leakage ratio (SLR).

13. The method of claim 11, further comprising:
determining a second gain region from a plurality of gain regions corresponding to a second beam index of a plurality of beam indices associated with serving a respective plurality of UE;
determining a plurality of interference regions corresponding to the plurality of beam indices based at least in part on determining the second gain region; and
calculating a second beamforming weight of a plurality of beamforming weights for the plurality of beam indices using the analog null algorithm, wherein the second beamforming weight has a maximum gain at the second gain region and a minimum gain at the plurality of interference regions corresponding to the plurality of beam indices.

14. The method of claim 11, further comprising:
adjusting a phase shifter value, at an antenna array configured to transmit one or more beams, wherein transmitting the first beam is based at least in part on adjusting the phase shifter value.

15. The method of claim 11, wherein:
the first UE and the second UE are located in a first cell.

16. The method of claim 11, wherein:
the first UE is located in a first cell; and
the second UE is located in a second cell, wherein the first cell is co-located to the second cell.

17. The method of claim 11, wherein:
the first UE is located in a first cell; and
the second UE is located in a second cell, wherein the first cell is non-co-located to the second cell.

18. The method of claim 11, further comprising:
determining an initial beamforming weight using a beam tracking algorithm or a beam management module, wherein determining the gain region of the first beam index is based at least in part on determining the initial beamforming weight.

19. The method of claim 8, further comprising:
comparing the initial beamforming weight to a second threshold criterion; and
determining the initial beamforming weight fails to satisfy the second threshold criterion, wherein calculating the beamforming weight of the first beam index is based at least in part on determining the initial beamforming weight fails to satisfy the second threshold criterion.

20. The method of claim 11, further comprising:
storing the beamforming weight of the first beam index.
